(19) United States
(12) Patent Application Publication
(10) Pub. No.: US 2003/0218680 A1
(43) Pub. Date: Nov. 27, 2003

(54) Color area sensor and image pick up circuit

(76) Inventor: Ryuichi Shiohara, Matsumoto-shi (JP)

Correspondence Address: HARNESS, DICKEY & PIERCE, P.L.C., P.O. BOX 828, BLOOMFIELD HILLS, MI, 48303, US

(21) Appl. No.: 10/422,625

(22) Filed: Apr. 24, 2003

(30) Foreign Application Priority Data
Apr. 26, 2002 (JP) 2002-126629

(51) Int. Cl. H04N 3/14; H04N 5/335

(52) U.S. Cl. 348/308

(57) ABSTRACT

CMOS type image sensors G (1,1), B (1,3), . . . , G (7,11) arranged at coordinates of virtual triangle lattices formed by arranging virtual equilateral triangles, color filters FG (1,1), FG (1,7), . . . , FG (7,7) transmitting G (green) light, color filters FB (1,3), FB (1,9), . . . , FB (7,9) transmitting B (blue) light, and color filters FR (1,5), FR (1,11), . . . , FR (7,11) transmitting R (red) light are provided.

### BACKGROUND OF THE INVENTION

1. Technical Field of the Invention

The present invention relates to a color area sensor with high color resolution. More particularly, the present invention relates to an image-pickup circuit including such a color area sensor. Related Art

An area sensor picking up an image has many image sensors, which are electronic eyes. Furthermore, in a color area sensor picking up a color image, color filters transmitting three primary color lights such as R (red), G (green) and B (blue) are usually arranged on light-receiving surfaces of image sensors.

FIG. 15 is a figure showing one example of such a conventional color area sensor. As shown in FIG. 15, a color area sensor 90 comprises image sensors arranged in a matrix, a color filter transmitting R (red) light, a color filter transmitting G (green) light and a color filter transmitting B (blue) light, which are located on light-receiving surfaces of image sensors.

FIG. 16 is a figure showing another example of a conventional color area sensor. As shown in FIG. 16, a color area sensor 91 comprises image sensors arranged in a honeycomb-shaped, a color filter transmitting by R (red) light, a color filter transmitting G (green) light and a color filter transmitting B (blue) light, which are located on light-receiving surfaces of image sensors.

Such arrangement of image sensors and arrangement of color filters relate greatly to resolution of an image, color resolution, color reproduction, while these greatly affect the ease of processing in an image processing circuit, processing an image signal outputted by a color area sensor and simplification of an image processing circuit.

In the conventional color area sensor shown in FIG. 15 and FIG. 16, image sensors are located at coordinates of a virtual square lattice constituted by arranging a virtual quadrangle. On the other hand, color filters are generally three kinds such as transmitting R (red) light, transmitting G (green) light and transmitting B (blue) light, and do not coincide with the number of corners of a virtual quadrangle. Therefore, as shown in FIG. 15 and FIG. 16, the number of green filters, which are highly sensitive to human eyes, are larger than the number of other two color filters such that there is a problem in color reproduction. In other words, there is a problem that color resolution of R (red) and B (blue) is bad.

In addition, in a conventional area sensor, an image sensor having a CCD (a charge coupled device) transmission circuit (it is referred to as “a CCD image sensor” hereafter) is mainly used. However, a CCD image sensor lacks freedom of arrangement due to the necessity of an image signal transfer line for transferring an image signal (a transfer line generally needs a wide area because of including structural elements and structures on process). FIG. 17 is a figure showing inside wiring for transmission of a conventional color area sensor of progressive type provided with a CCD image sensor. As shown in FIG. 17, a color area sensor 92 is provided with an image signal transfer line along the sub scanning line direction.

On the other hand, a CMOS type image sensor manufactured by a CMOS production process basically enables scanning with an XY matrix. Arrangement of a CMOS type image sensor has high freedom since there is no need for an image signal transfer line installed in a CCD image sensor, and only wiring signal lines such as aluminum used in a CMOS process are needed instead.

By the way, Japanese patent application laid open Tokai Hei 6-43316 (it is referred to as “document 1” hereafter) discloses a color matrix screen including color filters arranged in a triad, namely a triangles arrangement wherein a pixel comprises two sub pixels located adjacently and arranged along with rows and columns in a matrix, n (n is an odd or even number) rows of color filters are arranged in the order of A, A, B, B, C, C when A, B and C show any combination of red, green and blue, n+1 rows of color filters are arranged in the order of C, C, A, A, B, B, one sub pixel is shifted at the end of each row. Further, in this document 1, each column comprises two parallel column elements connected to each other at each end, and each of two sub pixels located adjacently in a row having the same color filters is connected to different column elements.

However, the color matrix screen disclosed in document 1 is for displaying an image, not for picking up an image. In addition, in the color matrix screen disclosed in document 1, a pixel comprises two sub pixels located adjacently and arranged along with rows and columns in a matrix. Furthermore, in the color matrix screen of the documents 1, color filters at each row are arranged in a sequence of A, A, B, B, C, C or C, C, A, A, B, B and color filters having the same color are set by every 2 pieces in a row direction.

Thus, in view of the above, the first object of the present invention is to provide a color area sensor with high color resolution. Furthermore, the second object of the present invention is to provide an image-pick up circuit including such a color area sensor.

### SUMMARY

In order to overcome the above problem, a color area sensor of the present invention comprises: a plurality of image sensors located at coordinates of a virtual triangle lattice constituted by virtually arranging triangles and a first, second and third color filter arranged on the light-receiving surfaces of a plurality of the image sensors and transmitting first, second and third colors.

Here, the first, second and third color may include R (red), G (green) and B (blue) or Cy (cyan), Ye (yellow) and Mg (magenta). The triangles may be equilateral triangles. The triangles may be isosceles triangles or right-angled isosceles triangles.

Further the first color filters may be located on the light-receiving surfaces of the image sensors at J column (J=a natural number), the second color filters may be located on the light-receiving surfaces of the image sensors at J+1 column and the third color filters may be located on the light-receiving surfaces of the image sensors at J+2 column. Further, the first color filters may be located on the light-receiving surfaces of the image sensors at K (K=a natural number) row, the second color filters may be located on the light-receiving surfaces of the image sensors at K+1 row and the third color filters may be located on the light-receiving surfaces of the image sensors at K+2 row.

Further, the first, second and third color filters may be located at the three vertices of the isosceles triangles formed on coordinates at L (L=a natural number) and L+1 rows, the color filters transmitting any two colors of the first and the second colors, the first and the third colors or the second and the third colors may be located at the three vertices of an isosceles triangle formed on coordinates at L+1 (L=a natural number) and L+2 rows. Further, the first color filters are located on the light-receiving surfaces of the image sensors at M (M=a natural number) row, the second and the third color filters are alternatively located on the light-receiving surfaces of the image sensors at M+1 row. Further, the isosceles triangles may be right-angled isosceles triangles.

Further, an output line transmitting an image signal outputted from the image sensors at each column may be provided. An output line transmitting an image signal outputted from the image sensors at two columns located adjacent to each other may be provided. The output line may be a polygonal-shaped line.

Further, the image sensors may be CMOS type image sensors. A selecting line transmitting a selection signal that selects the image sensors at each row may be provided. A selection line transmitting a selection signal that selects the image sensors at two rows located adjacent to each other may be provided. The selection line may be a polygonal-shaped line. The image sensors may be image sensors including CCD (charge coupled devices) transmission circuits.

An image-pick up circuit of the first mode of the present invention comprises the above mentioned color area sensor; a latch portion latching an output signal of the color area sensor; an amplifier amplifying an output signal of the latch portion, an A/D converter A/D converting the output signal of the amplifier; and an interpolation-processing portion interpolating the output signal from the A/D converter so as to calculate pixel data.

An image pick up circuit of the second mode of the present invention comprises: the above mentioned color area sensor provided with the first color filters located at predetermined lattice points (R,J) (R, J=a natural number); a latch portion latching an output signal of the color area sensor; an amplifier amplifying an output signal of the latch portion; an A/D converter A/D converting the output signal of the amplifier; and an interpolation-processing portion, amplifying and A/D converting output signals of the image sensors located at the lattice point (T, U) (T, U=natural numbers) into data Out (T,U), calculating pixel data of the first color VPD (((R+1), (J+3)), 1) at the first pixel VP ((R+1), (J+3)) by using a formula VPD(((R+1),(J+3)),1)=Out((R+1),(J+3)), calculating pixel data of the second color VPD (((R+1), (J+3)), 2) at the pixel VP ((R+1), (J+3)) by using a formula VPD(((R+1), (J+3)), 2)=⅓·(Out(R, (J+4))+Out((R+2), (J+4))+Out((R+1), (J+1))), and calculating pixel data of the third color VPD (((R+1), (J+3)), 3) at the pixel VP ((R+1), (J+3)) by using a formula VPD(((R+1),(J+3)),3)=⅓·(Out(R,(J+2))+Out((R+2),(J+2))+Out((R+1),(J+5))), based on the data Out(T,U).

An image pick up circuit of the third mode of the present invention comprises: the above mentioned color area sensor provided with first color filters located at predetermined lattice points (R,J) (R, J=a natural number);a latch portion latching an output signal of the color area sensor; an amplifier amplifying an output signal of the latch portion; an A/D converter A/D converting the output signal of the amplifier; and an interpolation-processing portion, amplifying and A/D converting output signals of the image sensors located at the point (T, U) (T, U=natural numbers) into data Out (T,U), calculating pixel data of first color VPD (((R+2), (J+3)), 1) at the first pixel VP ((R+2), (J+3)) by using a formula VPD(((R+2),(J+3)),1)=½ (Out((R+1),(J+3))+Out((R+3),(J+3))), calculating pixel data of the second color VPD (((R+2), (J+3)), 2) at the pixel VP ((R+2), (J+3)) by using a formula VPD(((R+2),(J+3)),2)=⅙ (Out((R+1),(J+1))+Out((R+3),(J+1))+Out((R+2),(J+4))), and calculating pixel data of the third color VPD (((R+2), (J+3)), 3) at the pixel VP ((R+2), (J+3)) by using a formula VPD (((R+2),(J+3)),3)=⅙· (Out ((R+1), (J+5))+Out ((R+3), (J+5)+4-Out ((R+2),(J+2))) based on the data Out(T, U).

An image pick up circuit of the fourth mode of the present invention comprises: the above mentioned color area sensor provided with first color filters located at predetermined lattice points (R, J) (R, J=a natural number); a latch portion latching an output signal of the color area sensor; an amplifier amplifying an output signal of the latch portion; an A/D converter A/D converting the output signal of the amplifier; and an interpolation portion amplifying and A/D converting output signals of the image sensors located at the lattice point (T, U) (T, U=natural numbers) into data Out (T,U), calculating a pixel data of the first color VPD (((R+1), (J+2)), 1) at the first pixel VP ((R+1), (J+2)) by using a formula VPD (((R+1), (J+2)), 1)=⅙·(Out(R,J)+Out((R+2),J)+4 ·Out((R+1),(J+3))), calculating a pixel data of the second color VPD (((R+1), (J+2)), 2) at the pixel VP ((R+1), (J+2)) by using a formula VPD(((R+1),(J+2)),2)=⅙·(Out(R,(J+4))+Out((R+2),(J+4))+4Out((R+1),(J+1))), and calculating a pixel data of the third color VPD (((R+1), (J+2)), 3) at the pixel VP ((R+1), (J+2)) by using a formula VPD(((R+1),(J+2)),3)=½·(Out(R,(J+2))+Out((R+2),(J+2))), based on the data Out(T,U).

An image pick up circuit of the fifth mode of the present invention comprises: the above mentioned color area sensor provided with the first color filters located at a predetermined lattice point (R,J) (R, J=natural numbers); a latch portion latching an output signal of the color area sensor; an amplifier amplifying an output signal of the latch portion; an A/D converter A/D converting the output signal of the amplifier; and an interpolation-processing portion amplifying and A/D converting output signals of the image sensors located at the point (T, U) (T, U=natural numbers) into data Out (T,U), calculating a pixel data of the first color VPD (((R+2), (J+2)), 1) at the first pixel VP ((R+2), (J+2)) by using a formula VPD (((R+2), (J+2)), 1)=1/3·(Out(R+2,J)+Out((R+1),(J+3)+Out((R+1),(J+3))), calculating pixel data of the second color VPD (((R+2), (J+2)), 2) at the pixel VP ((R+2), (J+2)) by using a formula VPD (((R+2),(J+2)),2)=⅓·(Out((R+1), (J+1))+Out((R+3),(J+1))+Out((R+2),(J+4))), calculating pixel data of the third color VPD (((R+2), (J+2)), 3) at the pixel VP ((R+2), (J+2)) by using a formula VPD(((R+2),(J+2)),3)=Out((R+2),(J+2)) based on the data Out (T,U).

According to a color area sensor related to the present invention, color resolution can be improved. In addition, according to an image-pick up circuit related to the present invention, pixel data of which the number are two times of that of image sensors in a color area sensor can be generated.

### BRIEF DESCRIPTION OF THE DRAWINGS

FIG. 1 is a schematic figure showing a color area sensor related to the first embodiment of the present invention.

FIG. 2 is a schematic figure showing a color area sensor related to the second embodiment of the present invention.

FIG. 3 is a figure showing inside wiring of the color area sensor related to the second embodiment of the present invention.

FIG. 4 is a schematic figure showing a color area sensor related to the third embodiment of the present invention.

FIG. 5 is a schematic figure showing a color area sensor related to the fourth embodiment of the present invention.

FIG. 6 is a schematic figure showing a color area sensor related to the fifth embodiment of the present invention.

FIG. 7 is a schematic figure showing a color area sensor related to the sixth embodiment of the present invention.

FIG. 8 is a schematic figure showing a color area sensor related to the seventh embodiment of the present invention.

FIG. 9 is a schematic figure showing a color area sensor related to the eighth embodiment of the present invention.

FIG. 10 is a schematic figure showing a color area sensor related to the ninth embodiment of the present invention.

FIG. 11 is a schematic figure showing a color area sensor related to the tenth embodiment of the present invention.

FIG. 12 is a schematic figure showing a color area sensor related to the eleventh embodiment of the present invention.

FIG. 13 is a schematic figure showing an image-picking circuit related to one embodiment of the present invention.

FIG. 14 is an enlarged figure of one part of the color area sensor in FIG. 13.

FIG. 15 is a schematic figure showing a conventional color area sensor.

FIG. 16 is a schematic figure showing a conventional color area sensor.

FIG. 17 is a schematic figure showing a conventional color area sensor.

### DETAILED DESCRIPTION

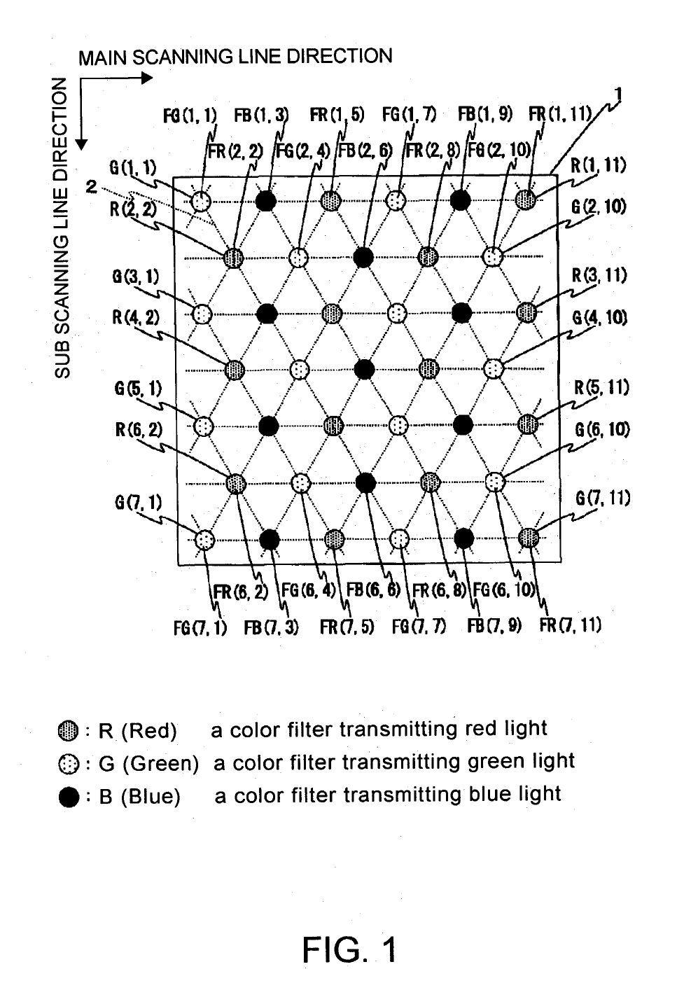

A preferred embodiment of the present invention will be explained referring to drawings. Here, the same reference numbers refer to the same elements, and duplicate explanation thereof is omitted. FIG. 1 is a schematic figure showing a color area sensor related to the first embodiment of the present invention. As shown in FIG. 1, a color area sensor 1 is provided with CMOS image sensors G (1,1), B (1,3), . . . , G (7,11) (here, a CMOS image sensor is a sensor formed by a CMOS manufacturing process), color filters FG (1,1), FG (1,7), . . . , FG (7,7) transmitting G (green) light, color filters FB (1,3), FB (1,9), . . . , FB (7,9) transmitting B(blue) light and color filters FR (1,5), FR (1,11), . . . , FR (7,11) transmitting R (red) light.

In the color area sensor 1, virtual triangle lattices constituted by arranging virtual equilateral triangles (these are referred to as “virtual equilateral triangles”) are set such that the image sensors G (1,1), B (1,3), . . . , G (7,11) are located at coordinates of these virtual triangle lattices.

On light-receiving surfaces of three image sensors located at three vertices of all virtual equilateral triangles of the color area sensor 1, a color filter transmitting G (green) light, a color filter transmitting B (blue) light, and a color filter transmitting R (red) light are arranged. For example, on a light-receiving surface of the image sensor G (1,1) located at a vertex of the virtual equilateral triangle 2, the color filter FG (1,1) transmitting G (green) light is arranged. On a light-receiving surface of the image sensor B (1,3), a color filter FB (1,3) transmitting B (blue) light is arranged. On a light-receiving surface of the image sensor R (2,2), a color filter FR (2,2) transmitting R (red)) light is arranged.

Similarly, in any virtual equilateral triangle other than the virtual equilateral triangle 2, color filters transmitting G (green) light, color filters transmitting B (blue) light and color filters transmitting R (red) light are located on light-receiving surfaces of the image sensors located of three vertices of these triangles.

In addition, on light-receiving surfaces of a pair of the image sensors located adjacently within the image sensors G (1,1), B (1,3), . . . ,G(7,11), color filters transmitting different color lights are arranged. In other words, a color filter transmitting G (green) light, a color filter transmitting B (blue) light and a color filter transmitting R (red) light are arranged symmetrically and in a pattern. Therefore, according to the present embodiment, a problem in a conventional color area sensor that color resolution of R (red) and B (blue) is bad can be avoided.

In addition, a CCD mainly used in a conventional color area sensor needs an image signal transfer line and is not easily disposed freely. However, according to the present embodiment, the image sensors G (1,1), B (1,3), . . . , G (7,11) are CMOS type image sensors outputting image signals to signal lines. Wiring of this signal line is similar to wiring of a general LSI, with possible versatility. Therefore, as shown in FIG. 1, it is possible to allocate the image sensors G (1,1), B (1,3), . . . , G (7,11) at the vertices of a virtual triangle lattice.

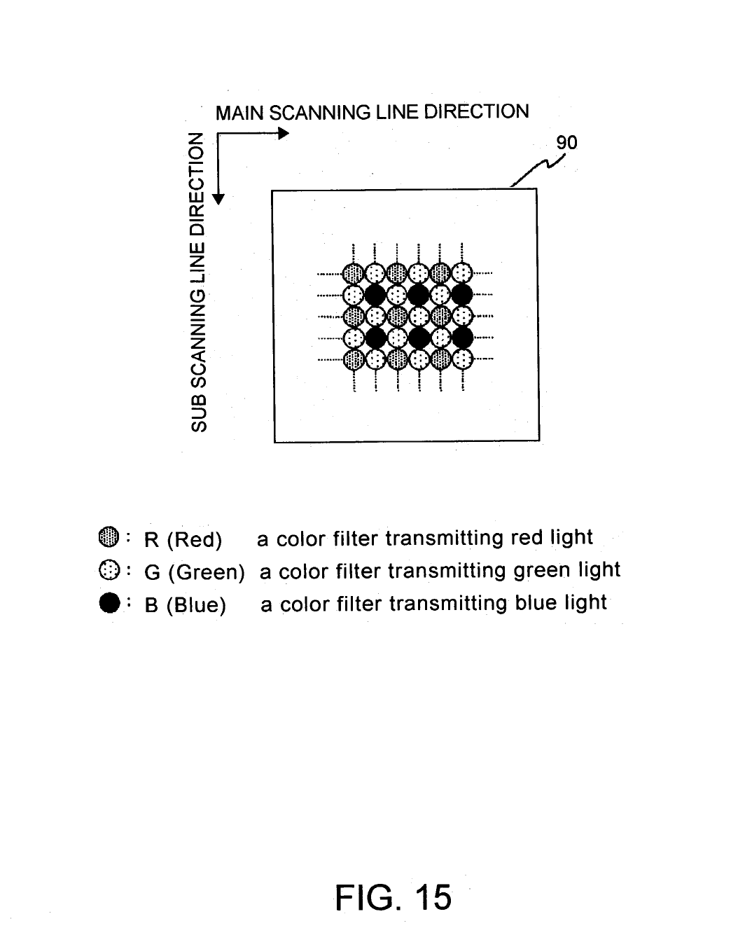

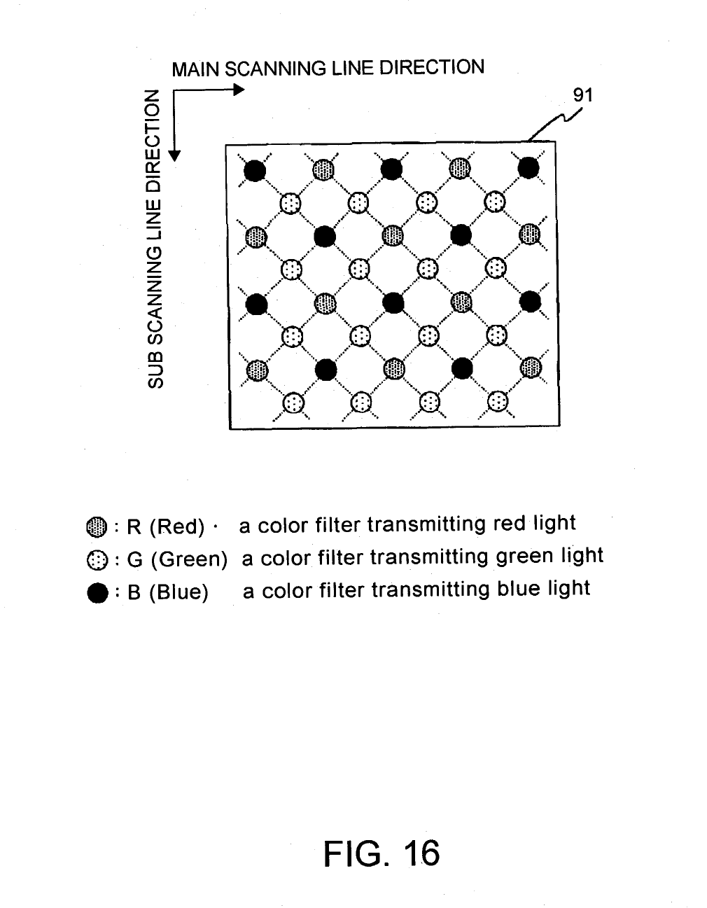

In addition, in the conventional color area sensors 90, 91 shown in FIG. 15 and FIG. 16, image sensors are arranged in a square-shape. On the other hand, in the present embodiment, image sensors G (1,1), B (1,3), . . . , G (7,11) are arranged in an equilateral triangle shape.

In addition, in the present embodiment, color filters transmitting three primary color lights such as R (red), G (green) and B (blue) are used. But color filters of Cy (cyan), Mg (magenta) and Ye (yellow), which are complementary colors of the above may be used.

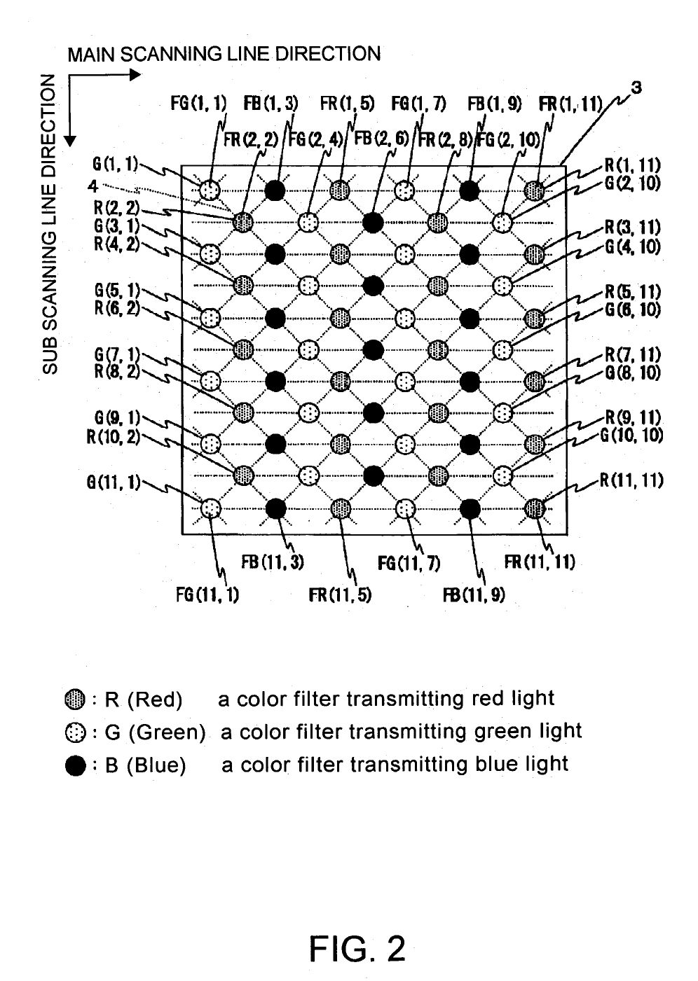

Next, a color area sensor related to the second embodiment of the present invention is described. FIG. 2 is a schematic figure showing a color area sensor related to the second embodiment of the present invention. As shown in FIG. 2, a color area sensor 3 comprises CMOS type image sensors G (1,1), B (1,3), . . . , R (11,11), color filters FG (1,1), FG (1,7), . . . , FG (11,7) transmitting G(green) light, color filters FB (1,3), FB (1,9), . . . , FB (11,9) transmitting B(blue) light and color filters FR (1,5), FR (1,11), . . . , FR(11,11) transmitting R(red) light. In the color area sensor 3, virtual triangle lattices constituted by arranging virtual isosceles triangles (these are referred to as “virtual isosceles triangles” hereafter) are set such that the image sensors G (1,1), B (1,3), . . . , R (11,11) are located at coordinates of this virtual triangle lattice.

On light-receiving surfaces of three image sensors located at three vertices of each virtual isosceles triangle of the color area sensor 3, a color filter transmitting G (green) light, a color filter transmitting B (blue) light, and a color filter transmitting R (red) light are arranged. For example, on the light-receiving surface of the image sensor G (1,1) located at a vertex of the virtual isosceles triangle 4, the color filter FG (1,1) transmitting G (green) light is arranged. On the light-receiving surface of the image sensor B (1,3), the color filter FB (1,3) transmitting B (blue) light is arranged. On the light-receiving surface of the image sensor R (2,2), the color filter FR (2,2) transmitting R (red) light is arranged.

Similarly, in any virtual isosceles triangle other than the virtual isosceles triangle 4, color filters transmitting G (green) light, color filters transmitting B (blue) light and color filters transmitting R (red) light are arranged on the light-receiving surfaces of the image sensors located at three vertices of these triangles. In addition, on light-receiving surfaces of a pair of image sensors located adjacently within the image sensors G (1,1), B (1,3), . . . ,R (11,11), color filters transmitting different color lights are arranged.

Therefore, the color filter transmitting G (green) light, the color filter transmitting B (blue) light and the color filter transmitting R (red) light are arranged symmetrically and in a pattern. These image sensors G (1,1), B (1,3), . . . , R (11,11) receive light of R (red), G (green) or B (blue) transmitted through these color filters and output image signals in response to a quantity of received light.

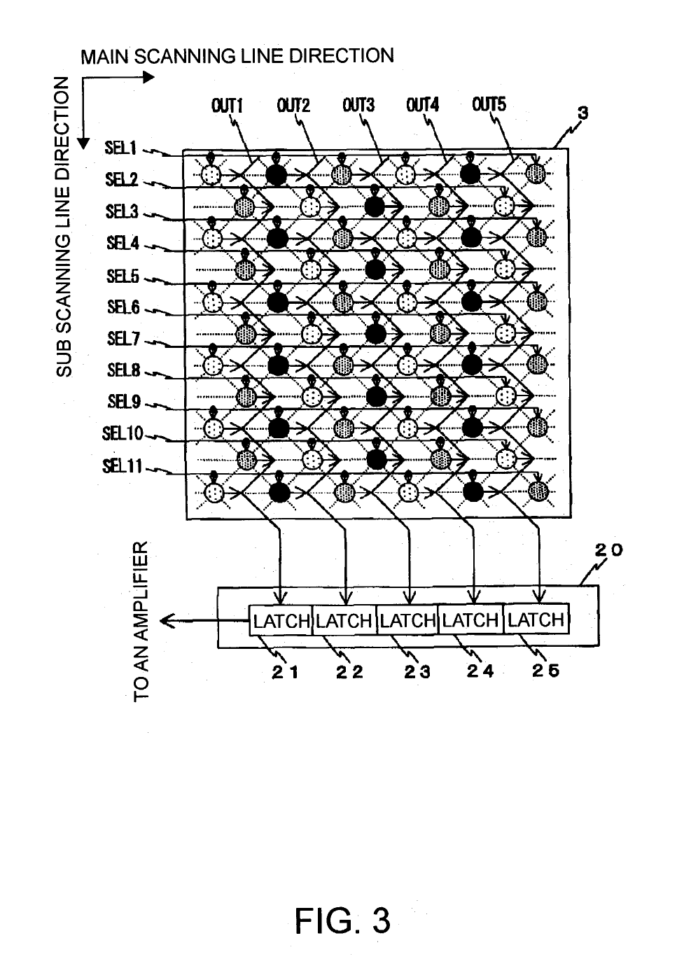

FIG. 3 is a figure showing an example of inside wiring of the color area sensor 3. As shown in FIG. 3, within the color area sensor 3, selection lines SEL1 . . . SEL11 transmitting a selection signal to select an image sensor are arranged along with the main scanning line. The selection line SEL1 is connected to the image sensors G (1,1), B (1,3), . . . , R (1,11), the selection line SEL2 is connected to the image sensors R (2,2), . . . , G (2,10) and the selection line SEL3 is connected to the image sensors G (3,1), . . . , R (3,11).

In addition, the selection line SEL4 is connected to the image sensor R (4,2), . . . , G (4,10), the selection line SEL5 is connected to the image sensors G (5,i), . . . , R (5,11), the selection line SEL6 is connected to the image sensors R (6,2), . . . , G (6,10). In addition, the selection line SEL7 is connected to the image sensors G (7,1), . . . , R (7,11), the selection line SEL8 is connected to the image sensors R (8,2), . . . , G (8,10) and the selection line SEL9 is connected to the image sensors G (9,1), . . . , R (9,11).

Furthermore, the selection line SEL10 is connected to the image sensors R (10,2), . . . , G (10,10) and the selection line SEL11 is connected to the image sensors G (11,1), . . . , R (11,11).

In addition, as shown in FIG. 3, polygonal line-shaped output lines OUT1 . . . OUT5 transmitting an output signal of the image sensor are arranged in the direction of the sub scanning line of the image sensor 3. The output line OUT1 is connected to the image sensors G (1,1), R (2,2), . . . , G (11,1) at two columns in the sub scanning line direction. Similarly, the output line OUT2 is connected to the image sensors B (1,3), G (2,4), . . . , B (11,3) at two columns in the sub scanning line direction and the output line OUT3 is connected to the image sensors R (1,5), B (2,6), . . . , R (11,5) at two columns in the sub scanning line direction.

In addition, the output line OUT4 is connected to the image sensors G (1,7), R (2,8), . . . , G (11,7) at two columns in the sub scanning line direction and the output line OUT5 is connected to the image sensors B (1,9), G (2,10), . . . , B (11,9) at two columns in the sub scanning line direction.

Therefore, two image signals of G (green) and R (red) are outputted from the output line OUT1, two image signals of B (blue) and G (green) are outputted from the output line OUT2, two image signals of R (red) and B (blue) are outputted from the output line OUT3, two image signals of G (green) and R (red) are outputted from the output line OUT4 and two image signals of B (blue) and G (green) are outputted from the output line OUT5.

These image signals outputted from these image sensors G (1,1), B (1,3), . . . , R (11,11) to these output lines OUT1 to OUT5 are latched by latch circuits 21-25 in a latch portion 20 of the color area sensor 3, outputted toward a reverse direction of the main scanning line direction, and transmitted to an amplifier.

As discussed above, according to the present embodiment, arrangement of a color filter transmitting G (green) light, a color filter transmitting B (blue) light and a color filter transmitting R (red) light are symmetrical and in a pattern such that it is possible to solve a problem where a color resolution of R (red) and B (blue) is bad in a conventional color area sensor.

In addition, according to the present embodiment, the number of the output lines in the sub scanning line direction can be ½ since the output line is connected to image sensors at two columns in the sub scanning line direction. The effect of making the number of the output lines half is very big since the larger (smaller) the number of the output lines toward the sub scanning line direction, the larger (smaller) the area of the color area sensor 3 is.

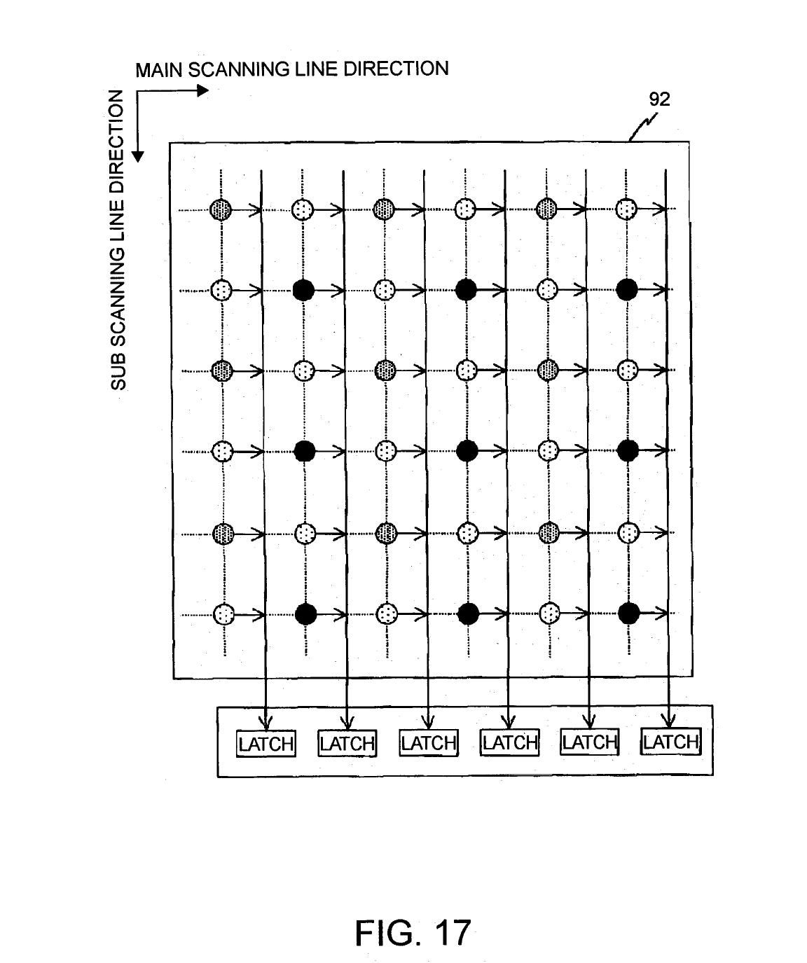

In addition, in the color area sensor 3, the image sensors G (1,1), B (1,3) and R (2,2) form a virtual isosceles triangle with a vertex at the R (2,2). But when it is a right-angled isosceles triangle with a vertex at the R (2,2), for example, the angle between a virtual line connecting the image sensors G (1,1) and B (1,3) and a virtual line connecting the image sensors B (1,3) and R (2,2) is 45 degrees. In addition, color arrangement of color filters in the color area sensor 3 is different from color arrangement of color filters in the conventional color area sensor shown in FIG. 15 . . . FIG. 17.

In addition, in the color area sensor 3, arrangement of color filters has repetition of G (green)→B (blue)→R (red)→G (green)→ . . . in the main scanning line direction. But, this is only one of example and arrangement of this color filter may be repetition of G (green)→R (red)→B (blue)→G (green)→ . . .

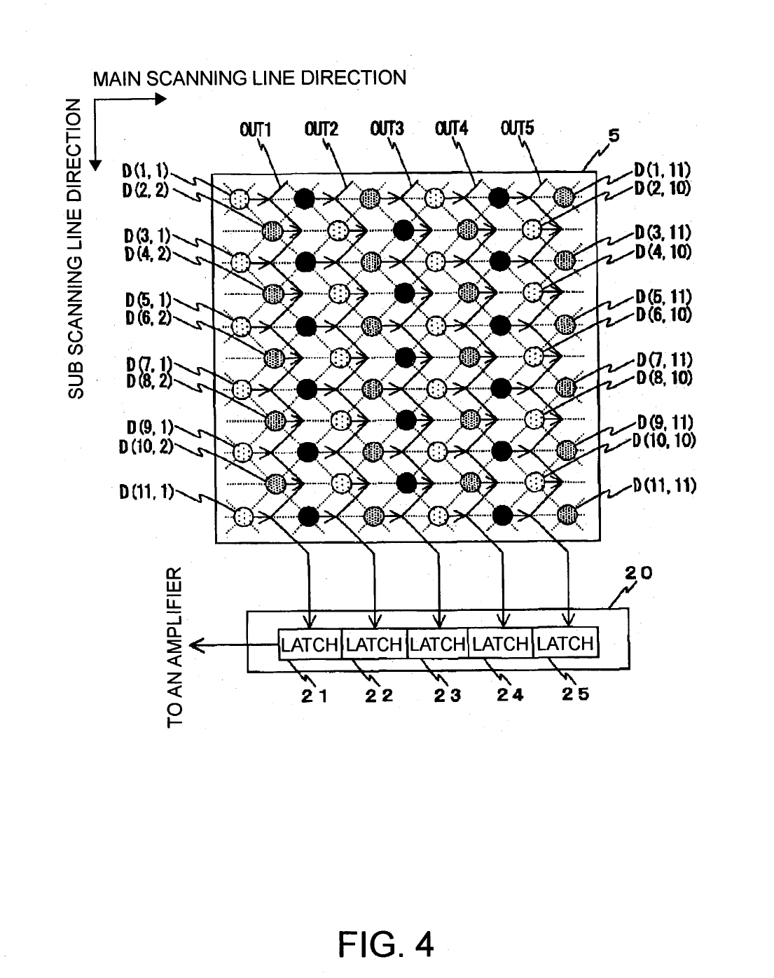

Next, a color area sensor related to the third embodiment of the present invention is described. FIG. 4 is a schematic figure showing a color area sensor related to the third embodiment of the present invention. As shown in FIG. 4, a color area sensor 5 comprises image sensors D (1,1) . . . D (11,11) using CCD transmission circuits, color filters FG (1,1), FG (1,7), . . . , FG (11,7) transmitting G (green) light, color filters FB (1,3), FB (1,9), . . . , FB (11,9) transmitting B (blue) light, color filters FR (1,5),FR (1,11), . . . , FR (11,11) transmitting R (red) light and output lines OUT1 to OUT5.

The color area sensor 5 is provided with image sensors using CCD transmission circuits replacing the CMOS type image sensors of the color area sensor 3. Hence, selection lines installed in the color area sensor 3 are not provided. In addition, the image sensors D (1,1) to D (11,11), and the color filters are arranged similarly to that of the color area sensor 3.

As discussed above, according to the present embodiment, color filters transmitting G (green) light, color filters transmitting B (blue) light and color filters transmitting R (red) light are arranged symmetrically and in a pattern such that it is possible to solve a problem where a color resolution of R (red) and B (blue) is bad in a conventional color area sensor.

In addition, according to the present embodiment, the number of the output lines in the sub scanning line direction can be ½ since the output line is connected to image sensors at two columns in the sub scanning line direction. The effect of making the number of the output lines half is very big since the larger (smaller) the number of the output lines toward the sub scanning line direction, the larger (smaller) the area of the color area sensor.

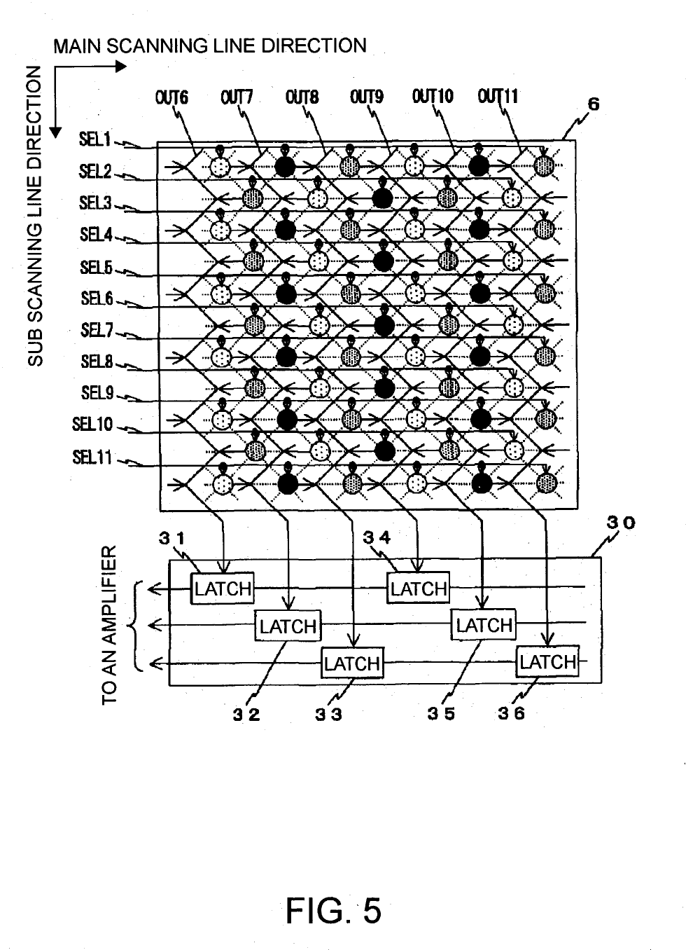

Next, a color area sensor related to the fourth embodiment of the present invention is described. FIG. 5 is a schematic figure showing a color area sensor related to the fourth embodiment of the present invention. As shown in FIG. 5, a color area sensor 6 comprises CMOS type image sensors G (1,1), B (1,3), . . . , R (11,11), color filters FG (1,1), FG (1,7), . . . , FG (11,7) transmitting G (green) light, color filters FB (1,3), FB (1,9), . . . , FB (11,9) transmitting B (blue) light and color filters FR (1,5), FR (1,11), . . . , FR(11,11) transmitting R (red) light.

Within the color area sensor 6, selection lines SEL1 . . . SEL11 transmitting selecting signals to select image sensors are arranged along the main scanning line.

The selection line SEL1 is connected to the image sensors G (1,1), B (1,3), . . . , R (1,11), the selection line SEL2 is connected to the image sensors R (2,2), . . . , G (2,10) and the selection line SEL3 is connected to the image sensors G (3,1), . . . , R (3,11).

In addition, the selection line SEL4 is connected to the image sensors R (4,2), . . . , G (4,10), the selection line SEL5 is connected to the image sensors G (5,1), . . . , R (5,11), the selection line SEL6 is connected to the image sensors R (6,2), . . . , G (6,10).

In addition, the selection line SEL7 is connected to the image sensors G (7,1), . . . , R (7,11), the selection line SEL8 is connected to the image sensors R (8,2), . . . , G (8,10) and the selection line SEL9 is connected to the image sensors G (9,1), . . . , R (9,11).

Furthermore, the selection line SEL10 is connected to the image sensors R (10,2), . . . , G (10,10) and the selection line SEL11 is connected to the image sensors G (11,1), . . . , R (11,11).

In addition, as shown in FIG. 5, polygonal line-shaped output lines OUT6 . . . OUT11 transmitting output signals of image sensors are arranged in the sub scanning line direction of the image sensor 3. The output line OUT 6 is connected to the image sensor R (2,2), . . . , R (11,2) at one column in the sub scanning line direction.

In addition, the output line OUT7 is connected to the image sensors G (1,1) G (2,4), . . . , G (11,1) at two columns in the sub scanning line direction.

Similarly, the output line OUT8 is connected to the image sensors B (1,3), B (2,6), . . . , B (11,3) at two columns in the sub scanning line direction and the output line OUT9 is connected to the image sensors R(1,5), R (2,8), . . . , R (11,5) at two columns in the sub scanning line direction. The output line OUT10 is connected to the image sensors G (1,7), G (2,10), . . . , G (11,7) at two columns in the sub scanning line direction. In addition, the output line OUT11 is connected to the image sensors B (1,9), . . . , B (11,9) at one column in the sub scanning line direction.

Therefore, an image signal of R (red) is outputted from the output line OUT6, an image signal of G (green) is outputted from the output line OUT7, an image signal of B (blue) is outputted from the output line OUT8, an image signal of R (red) is outputted from the output line OUT9, an image signal of G (green) is outputted from the output line OUT10 and an image signal of B (blue) is outputted from the output line OUT11.

Image signals outputted to these output lines OUT6 to OUT11 from these image sensors G (1,1), B (1,3), . . . , R (11,11) are latched by latch circuits 31 to 36 in a latch portion 30 located outside of the color area sensor 6, outputted to a reverse direction of the main scanning line direction, and transmitted to an amplifier.

As discussed above, according to the present embodiment, an image signal of one color is outputted from one output line. Generally image signals of image sensors located adjacently are similar signals to each other. However, output voltage is different greatly due to the color difference of color filters. Therefore, it is necessary to use an amplifier of high-speed response for amplifying an output signal of the latch portion 30 since output signals of image sensors in the same row of the main scanning line fluctuate every image sensor.

However, according to the color area sensor 6, an image signal of one color is outputted from one output line such that an amplifier of low-level response can be used, power consumption is reduced, and the size of a circuit can be reduced. In addition, the amplification rate of each amplifier may be able to change every color. In addition, only a specific image signal can be outputted. Furthermore, the color area sensor capable of outputting an image signal for every color can be realized.

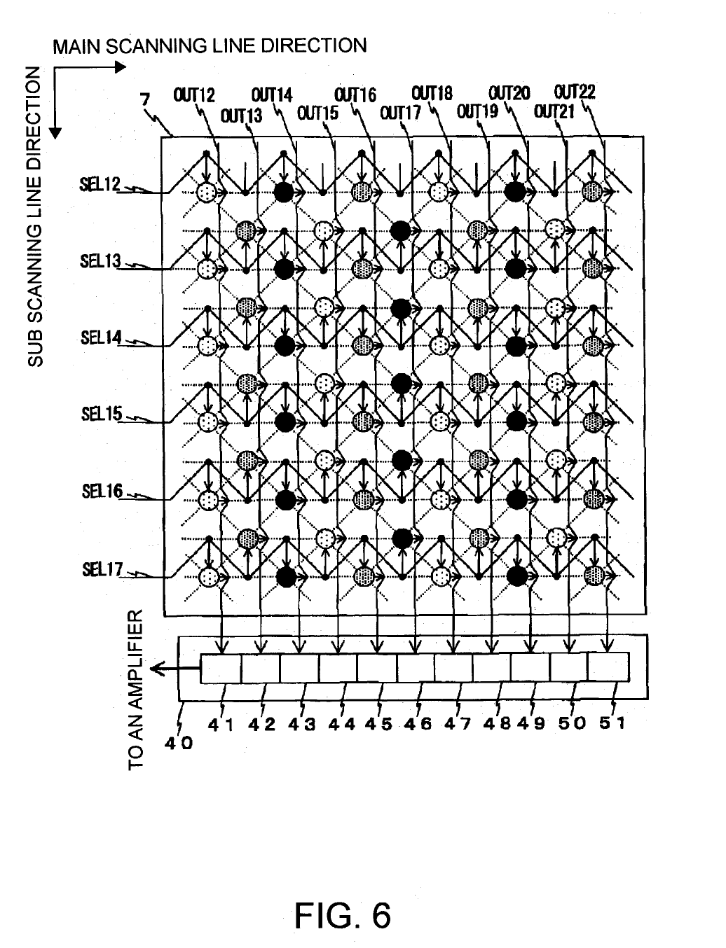

Next, a color area sensor related to the fifth embodiment of the present invention is described. FIG. 6 is a schematic figure showing a color area sensor related to the fifth embodiment of the present invention. As shown in FIG. 6, a color area sensor 7 comprises CMOS type image sensors G (1,1), B (1,3), . . . , R (11,11), color filters FG (1,1), FG (1,7), . . . , FG (11,7) transmitting G (green) light, color filters FB (1,3), FB (1,9), . . . , FB (11,9) transmitting B (blue) light and color filters FR (1,5), FR (1,11), . . . , FR(11,11) transmitting R (red) light.

In the color area sensor 7, polygonal line-shaped selection lines SEL12 . . . SEL 17 transmitting selection signals of selecting image sensors are located in the main scanning line direction. The selection line SEL12 is connected to the image sensors G (1,1), B (1,3) . . . , R (1, 11) at one row.

The selection line SEL13 is connected to the image sensors G (3,1), R (2,2). . . . R(3,11) at two rows, the selection line SEL14 is connected to the image sensors G(5,1), . . . ,R(5,11) at two rows, and the selection line SEL15 is connected to the image sensors G(7,1), . . . . R(7,11) at two rows. Similarly, the selection line SEL16 is connected to the image sensors G(9,1), . . . . R(9,11) at two rows, the selection line SEL17 is connected to the image sensors G(11,1), . . . R(11,11) at two rows.

In addition, as shown in FIG. 6, polygonal line-shaped output lines OUT12 to OUT22 transmitting an output signal of an image sensor are arranged in the sub scanning line direction of the image sensor 7. The output line OUT 12 is connected to the image sensors G (1,1), . . . , R (11,1) at one column in the sub scanning line direction. In addition, the output line OUT13 is connected to the image sensors R (1,1), . . . , R (10,2) at one column in the sub scanning line direction. The output line OUT14 is connected to the image sensors B (1,1), B (11,3) at one column in the sub scanning line direction.

Similarly, the output line OUT15 is connected to the image sensors G (2,4), . . . , G(10,4) at one column in the sub scanning line direction and the output line OUT16 is connected to the image sensors R(1,5), . . . , R (11,5) at one column in the sub scanning line direction. The output line OUT17 is connected to the image sensors B (2,6) . . . , B (10,6) at one column in the sub scanning line direction. In addition, the output line OUT18 is connected to the image sensors G (1,7), . . . , G(11,7) at one column in the sub scanning line direction and the output line. OUT19 is connected to the image sensors R (2,8), . . . , R (10,8) at one column in the sub scanning line direction. The output line OUT20 is connected to the image sensors B (1,9) . . . , B (11,9) at one column in the sub scanning line direction. Furthermore, the output line OUT21 is connected to the image sensors G (2,10), . . . , G(10,10) at one column in d the sub scanning line direction and the output line OUT22 is connected to the image sensors R (1,11), . . . , R (11,11) at one column in the sub scanning line direction.

Therefore, an image signal of G (green) is outputted from the output line OUT12, an image signal of R (red) is outputted from the output line OUT13, an image signal of B (blue) is outputted from the output line OUT14. In addition, an image signal of G (green) is outputted from the output line OUT15, an image signal of R (red) is outputted from the output line OUT16, an image signal of B (blue) is outputted from the output line OUT17. In addition, an image signal of G (green) is outputted from the output line OUT18, an image signal of R (red) is outputted from the output line OUT19, an image signal of B (blue) is outputted from the output line OUT20. Furthermore, an image signal of G (green) color is outputted from the output line OUT21 and an image signal of R (red) color is outputted from the output line OUT22.

These image signals outputted to output lines OUT12 to OUT22 from image sensors G (1,1), B (1,3), . . . , R (11,11) are latched by latch circuits 41 to 51 in the latch portion 40 outside of the color area sensor 7, outputted to a reverse direction of the main scanning line direction, and transmitted to amplifiers.

As discussed above, in the present embodiment, one selection line is connected to image sensors at two rows and these image sensors at two rows are selected by one selection signal. Therefore, the number of selection lines becomes ½ of the number of rows of image sensors. On the other hand, in the present embodiment, one output line is connected to image sensors at one column.

In addition, in the present embodiment, when interlaced scanning is implemented in the sub scanning line direction in preview operation, image signals of three colors R (red), G (green) and B (blue) are outputted in succession from one row. For example, in FIG. 6, when the selection signal is inputted to the selection line 17, an image signal of G (green) is inputted into the latch circuit 41, an image signal of R (red) is inputted into the latch circuit 42 and an image signal of B (blue) is inputted into the latch circuit 43. In addition, an image signal of G (green) is inputted into the latch circuit 44, an image signal of R (red) is inputted into the latch circuit 45 and an image signal of B (blue) is inputted into the latch circuit 46. In addition, an image signal of G (green) is inputted into the latch circuit 47, an image signal of R (red) is inputted into the latch circuit 48 and an image signal of B (blue) is inputted into the latch circuit 49. Furthermore, an image signal of G (green) is inputted into the latch circuit 50, an image signal of R (red) is inputted into the latch circuit 51.

In addition, according to the present embodiment, in case of interlaced scanning, there is an advantage where there is less color shift in an image signal such that the occurrence of doubtful color of an image in a preview can be restrained.

Furthermore, in the present embodiment, image sensors at two rows are selected by one-selection signal and image sensors at two rows output image signals. Therefore, the number of pixel output lines extended in the sub scanning line direction becomes 2 times of the number of columns of image sensors in the sub scanning line direction.

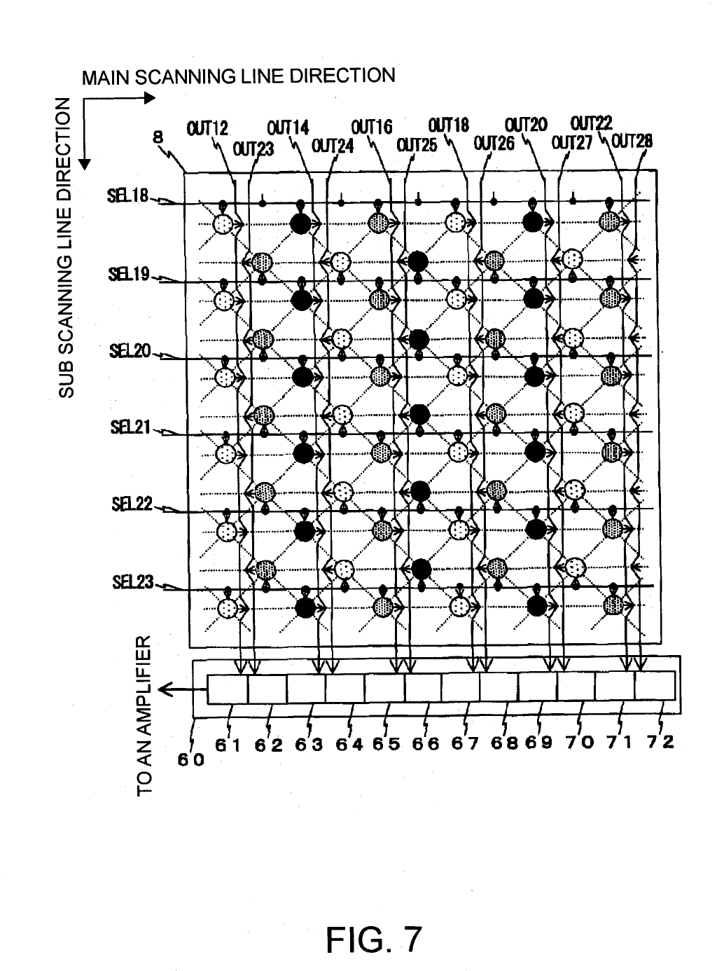

Next, a color area sensor related to the sixth embodiment of the present invention is described. FIG. 7 is a schematic figure showing a color area sensor related to the sixth embodiment of the present invention. As shown in FIG. 7, a color area sensor 8 comprises CMOS type image sensors G (1,1), B (1,3), . . . , R (11,11), color filters FG (1,1), FG (1,7), . . . , FG (11,7) transmitting G (green) light, color filters FB (1,3), FB (1,9), . . . , FB (11,9) transmitting B (blue) light and color filters FR (1,5), FR (1,11), . . . , FR(11,11) transmitting R (red) light.

In the color area sensor 8, linear line-shaped selection lines SEL18 to SEL 23 transmitting selection signals for selecting an image sensor are located in the main scanning line direction. The selection line SEL18 is connected to the image sensors G (1,1), B (1,3) . . . , R (1, 11) at one row.

The selection line SEL19 is connected to the image sensors G (3,1), R (2,2) . . . R(3,11) at two rows, the selection line SEL 20 is connected to the image sensors G(5,1), . . . , R(5,11) at two rows and the selection line SEL21 is connected to the image sensors G(7,1), . . . , R(7,11) at two rows. Similarly, the selection line SEL 22 is connected to the image sensors G (9,1), . . . R(9,11) at two rows, and the selection line SEL23 is connected to the image sensors G(11,1), . . . R(11,11) at two rows.

In addition, as shown in FIG. 7, polygonal line-shaped output lines OUT12, OUT14, OUT16, OUT18, OUT20, OUT22 and OUT23 to OUT28 transmitting output signals of an image sensor are located in the sub scanning line direction of the image sensor 8.

The output line OUT23 is connected to the image sensors R (2,2), . . . , R (10,2) at one column in the sub scanning line direction, the output line OUT24 is connected to the image sensors G(2,4), . . . , G (10,4) at one column in the sub scanning line direction and the output line OUT25 is connected to the image sensors B(2,6), . . . , B (10,6) at one column in the sub scanning line direction. Similarly, the output line OUT26 is connected to the image sensors R (2,8), . . . , R (10,8) at one column in the sub scanning line direction and the output line OUT27 is connected to the image sensors G (2,10), . . . , G (10,10) at one column in the sub scanning line direction.

Therefore, an image signal of R (red) is outputted from the output line OUT23, an image signal of G (green) is outputted from the output line OUT24, and an image signal of B (blue) is outputted from the output line OUT 25. In addition, an image signal of R (red) is outputted from the output line OUT 26 and an image signal of G (green) is outputted from the output line OUT 27.

These image signals outputted to output lines OUT12, OUT14, OUT16, OUT18, OUT20, OUT22 and OUT23 to OUT28 from image sensors G (1,1), B (1,3), . . . , R (11,11) are latched by latch circuits 61 to 72 in the latch portion 60 outside of the color area sensor 8 and outputted to a reverse direction of the main scanning line direction, and transmitted to an amplifier.

As discussed above, in the present embodiment, one selection line is connected to image sensors at two rows such that image sensors at two rows are selected by one selection signal. Therefore, the number of selection lines becomes ½ of the number of image sensors.

On the other hand, in the present embodiment, one output line is connected to image sensors at one column. In FIG. 7, locations of signal output lines are different from that in the embodiment shown in FIG. 6 such that it is possible to greatly enhance the versatility of possible arrangement and structure of sensors. These may be selected corresponding to a sensor structure.

In addition, in the present embodiment, when interlaced scanning is implemented in the sub scanning line direction in preview operation, image signals of three colors R (red), G (green) and B (blue) are outputted in succession from one row. For example, in FIG. 7, when a selection signal is inputted to the selection line 23, an image signal of G (green) is inputted into a latch circuit 61, an image signal of R (red) is inputted into a latch circuit 62, an image signal of B (blue) is inputted into a latch circuit 63. In addition, an image signal of G (green) is inputted into a latch circuit 64, an image signal of R (red) is inputted into a latch circuit 65, an image signal of B (blue) is inputted into a latch circuit 66. In addition, an image signal of G (green) is inputted into a latch circuit 67, an image signal of R (red) is inputted into a latch circuit 68, an image signal of B (blue) is inputted into a latch circuit 69.

Furthermore, an image signal of G (green) is inputted into a latch circuit 70, an image signal of R (red) is inputted into a latch circuit 71.

In addition, according to the present embodiment, in case of interlaced scanning, there is an effect where color shift of an image signal is small and the occurrence of doubtful color of an image in a preview can be restrained.

Furthermore, in the present embodiment, image sensors at two rows are selected by one-selection signal and image sensors at two rows output image signals. Therefore, the number of pixel output lines extended in the sub scanning line direction becomes 2 times the number of columns of image sensors in the sub scanning line direction.

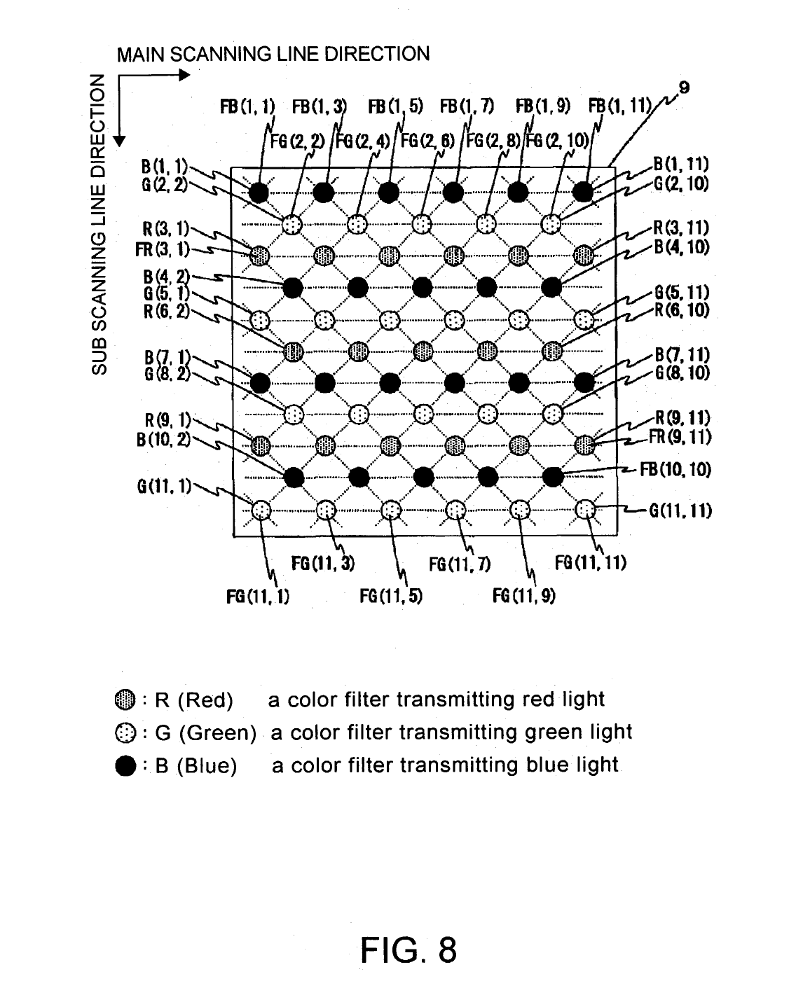

Next, a color area sensor related to the seventh embodiment of the present invention is described. FIG. 8 is a schematic figure showing a color area sensor related to the seventh embodiment of the present invention. As shown in FIG. 8, a color area sensor 9 comprises CMOS type image sensors G (1,1), B (1,3), . . . , G (11,11), color filters FB (1,1), FB (1,3), . . . , FB (10,10) transmitting B (blue) light, color filters FG (2,2), FG (2,4), . . . , FG (11,11) transmitting G (green) light and color filters FR (3,1), FR (3,3), . . . , FR (9,11) transmitting R (red) light.

In the color area sensor 9, virtual triangle lattices formed by arranging virtual isosceles triangles are set such that image sensors B (1,1), B (1,3), . . . , G (11,11) are located at coordinates of this virtual triangle lattice.

The color filters FB (1,1) FB (1,3) . . . FB (10,10) are located on the light-receiving surfaces of the image sensors B(1,1) to B(1,11), B(4,2) to B(4,10), B (7,1) to B(7,11), and B (10,2) to B(10,10), which are arranged along the main scanning line direction. The color filters FG (2,2), FG (2,4) . . . FG (1,11) are located on the light-receiving surfaces of the image sensors G(2,2) to G(2,10), G (5,1) to G(5,11),G(8,2) to G(8,10),and G (11,1) to G(11,11), which are arranged along the main scanning line direction.

The color filters FR (3,1) FR (3,3) . . . FR (9,11) are located on the light-receiving surfaces of the image sensors R(3,1) to R(3,11), R (6,2) to R(6,10), R(9.1) to R(9,11), which are arranged along the main scanning line direction.

Therefore, arrangement of color filters transmitting G (green) light, color filters transmitting B (blue) light and color filters transmitting R (red) light are symmetrical and in a pattern. Image sensors G (1,1), B (1,3), . . . , R (11,11) receive light such as R (red), G (green) or B (blue) and outputs image signals corresponding to a quantity of light.

Thus, according to the present embodiment, it is possible to solve a problem where color resolution of R (red) and B (blue) is bad in a conventional color area sensor.

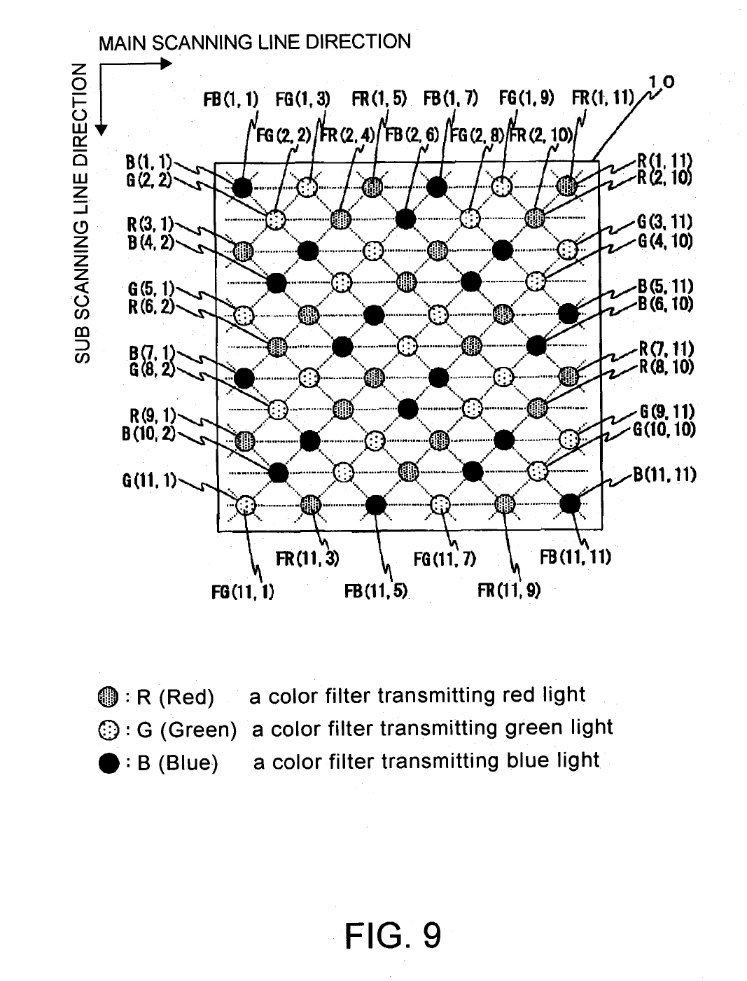

Next, a color area sensor related to the eighth embodiment of the present invention is described. FIG. 9 is a schematic figure showing a color area sensor related to the eighth embodiment of the present invention. As shown in FIG. 9, a color area sensor 10 comprises the CMOS type image sensors B (1,1), G (1,3), . . . , B (11,11), the color filters FB (1,1), FB (1,7), . . . , FB (11,11) transmitting B. (blue) light, the color filters FG (1,3), FG (1,9), . . . , FG (11,7) transmitting G (green) light and the color filters FR (1,5), FR (1,11), . . . , FR (11,9) transmitting R (red) light. In the color area sensor 10, virtual triangle lattices formed by arranging virtual isosceles triangles are set such that the image sensors B (1,1), B (1,3), . . . , G (11,11) are located at coordinates of this virtual triangle lattice.

On the light-receiving surfaces of the image sensors located at three vertices of each virtual isosceles triangles formed at the second and third rows of the color area sensor 10, color filters transmitting R (red) light, color filters transmitting G (green) light and color filters transmitting B (blue) light are arranged.

Similarly, on the light-receiving surfaces of the image sensors located at three vertices of each virtual isosceles triangle formed at the fourth and fifth rows, color filters transmitting R (red) light, color filters transmitting G (green) light and color filters transmitting B (blue) light are arranged.

Therefore, arrangement of color filters transmitting G (green) light, color filters transmitting B (blue) light and color filters transmitting R (red) light are symmetrical and in a pattern.

The image sensors G (1,1), B (1,3), . . . , R (11,11) receive light such as R (red), G (green) or B (blue) and outputs image signals corresponding to a quantity of light.

Thus, according to the present embodiment, it is possible to solve a problem where color resolution of R (red) and B (blue) is bad in a conventional color area sensor.

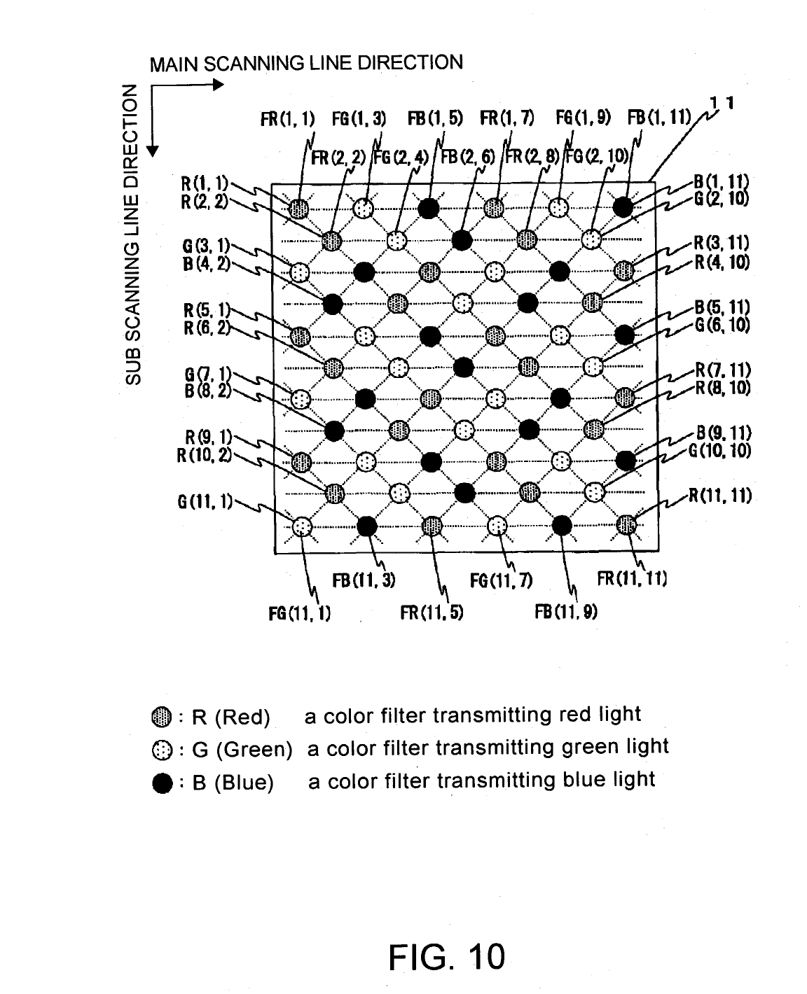

Next, a color area sensor related to the ninth embodiment of the present invention is described. FIG. 10 is a schematic figure showing a color area sensor related to the ninth embodiment of the present invention. As shown in FIG. 10, the color area sensor 9 comprises CMOS type image sensors R (1,1), G (1,3), . . . , R (11,11), color filters FR (1,1), FR (1,7), . . . , FR (11,11) transmitting R (red) light, color filters FG (1,3), FG (1,9), . . . , FG (11,7) transmitting G (green) light and color filters FB (1,5), FB (1,11), . . . , FB(11,9) transmitting B (blue) light.

In the color area sensor 11, the virtual triangle lattices formed by arranging virtual isosceles triangles are set such that image sensors R (1,1), G (1,3), . . . , R (11, 11) are located at coordinates of this virtual triangle lattice.

On the light-receiving surfaces of the image sensors located at three vertices of each of virtual isosceles triangles formed at the second and third rows of the color area sensor 11, a color filter transmitting R (red) light, color filters transmitting G (green) light and color filters transmitting B (blue) light are arranged.

Similarly, on the light-receiving surfaces of the image sensors located at the three vertices of each virtual isosceles triangle formed at the fourth and fifth rows, color filters transmitting R (red) light, color filters transmitting G (green) light and color filters transmitting B (blue) light are arranged.

Therefore, an arrangement of color filters transmitting G (green) light, color filters transmitting B (blue) light and color filters transmitting R (red) light are symmetrical and in a pattern.

The image sensors G (1,1), B (1,3), . . . , R (11,11) receive light such as R (red), G (green) or B (blue) and outputs image signals corresponding to a quantity of light.

Thus, according to the present embodiment, it is possible to solve a problem where the number of pixels for each color such as R (red), G (green) or B (blue) is the same and color resolution of R (red) and B (blue) is bad in comparison with that of G (green).

In addition, in the color area sensor 11, color filters are arranged so as to be R (red)→G (green)→B (blue)→R (red)→ . . . in the main scanning line direction. Such arrangement is different from that of the color area sensor 10 so as to be G (green)→R (red)→B (blue)→G (green)→ . . . in the main scanning line direction.

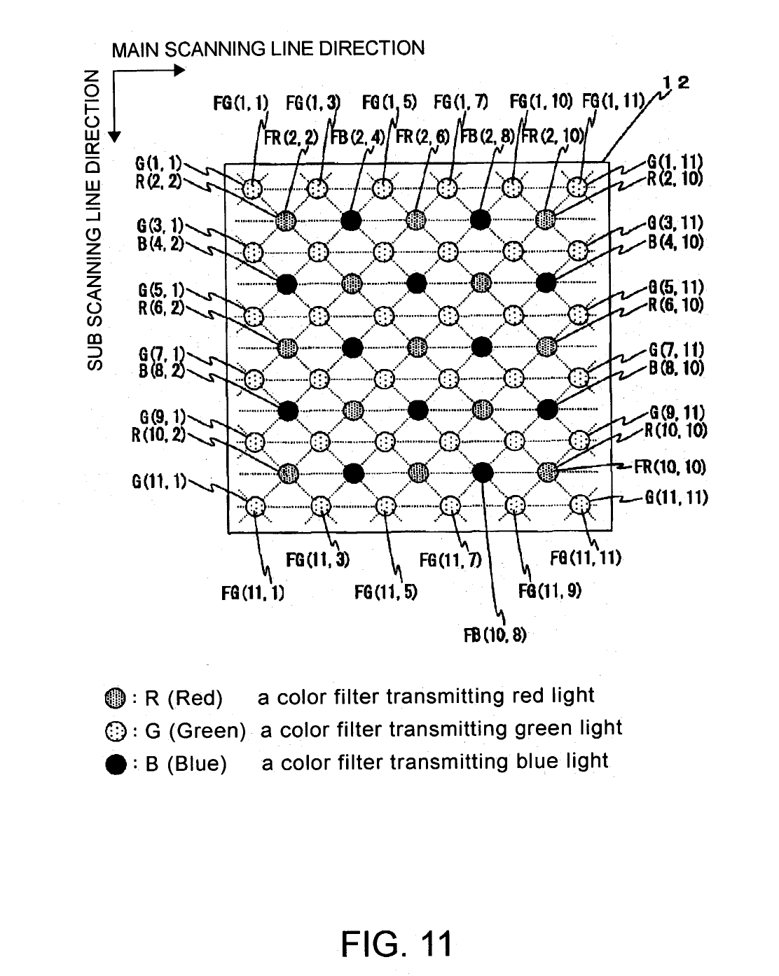

Next, a color area sensor related to the tenth embodiment of the present invention is described. FIG. 11 is a schematic figure showing a color area sensor related to the tenth embodiment of the present invention. As shown in FIG. 11, the color area sensor 12 comprises CMOS type image sensors G (1.1), G (1,3) . . . G (11,11), color filters FG (1,1), FG (1,3), . . . , FG (11,11) transmitting G (green) light, color filters FR (1,1), FR (1,7), . . . , FR (11,11) transmitting R (red) light, color filters FB (2,4), FB (2,8), . . . , FB (10,8) transmitting B (blue) light.

In the color area sensor 12, the virtual triangle lattices formed by arranging virtual isosceles triangles are set such that the image sensors R (1,1), G (1,3), . . . , R (11,11) are located at coordinates of this virtual triangle lattice.

The color filters FG (1,1), FG (1,3), . . . , FG (11,11) are arranged on the light-receiving surfaces of the image sensors G (1,1) to G (1,11), G (3,1) to G (3,11), G (5,1) to G (5,11), G (7,1) to G (7,11), G (9,1) to G (9,11) and G (11,1) to G (11,11) located at odd numbered rows (row 1, row 3, row 5, row 7, row 9 and row 11).

In addition, the color filters FR (2,2), FR (2,6), . . . , FR (10,10) and the color filters FB (2,4), FB (2,8), . . . , FB (10,8) are arranged alternately on the light-receiving surfaces of the image sensors R (2,2) to R (2,10), B (4,2) to B (4,10), R (6,2) to R (6,10) and B (8,2) to B (8,10) located at even numbered rows (row 2, row 4, row 6, row 8 and row 10). For example, at the second row, the color filters FR (2,2), FR (2,6) and FR (2,10) are arranged covering over the light surfaces of the image sensors R (2,2), R (2,6) and R (2,10). The color filters FB (2,4) and FR (2,8) are arranged covering over the light-receiving surfaces of the image sensors B (2,4) and R (2,8).

Therefore, arrangement of color filters transmitting G (green) light, color filters transmitting B (blue) light and color filters transmitting R (red) light are symmetrical and in a pattern. The image sensors G (1,1), B (1,3), . . . , R (11,11) receive light such as R (red), G (green) or B (blue) and outputs image signals corresponding to a quantity of light.

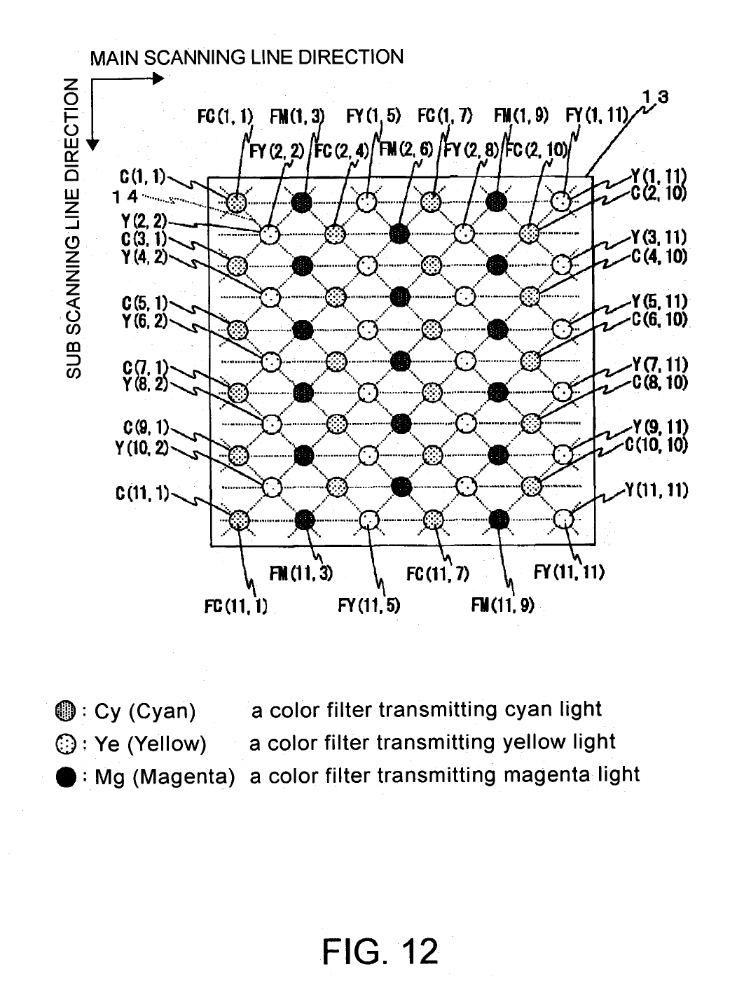

Next, a color area sensor related to the eleventh embodiment of the present invention is described. FIG. 12 is a schematic figure showing a color area sensor of the eleventh embodiment of the present invention. As shown in FIG. 12, a color area sensor 13 comprises CMOS type image sensors C (1,1), M (1,3), . . . , Y (11,11), color filters FC (1,1), FC (1,7), . . . , FC(11,7) transmitting Cy (cyan) light, color filters FM (1,3), FM (1,9), . . . , FM (11,9), FM (1,3), FM (1,9), . . . , FM (11,9) transmitting Mg (magenta) light and color filters FY (1,5), FY (1,11), . . . , FY (11,11) transmitting Ye (yellow) light.

In the color area sensor 13, virtual triangle lattices formed by arranging virtual isosceles triangles are set such that the image sensors C (1,1), M (1,3), . . . Y (11,11) are located at these coordinates of this virtual triangle lattice.

On the light-receiving surfaces of three image sensors located at the vertices of each virtual isosceles triangle of the color area sensor 13, color filters transmitting Cy (cyan) light, color filters transmitting Mg (magenta) light and color filters transmitting Ye (yellow) light are arranged. For example, on the light-receiving surface of the image sensor C (1,1) located at vertices of the virtual isosceles triangles 14, the color filter FC (1,1) transmitting Cy (cyan) light is located. On the light-receiving surfaces of the image sensors M (1,3), the color filter FM (1,3) transmitting light of Mg (magenta) is located. On the light-receiving surfaces of the image sensors Y (2,2), the color filter FY (2,2) transmitting light of Ye (yellow) is located.

Similarly, in any virtual isosceles triangles except the virtual isosceles triangle 14, on the light-receiving surfaces of image sensors located on vertices of them, color filters transmitting Cy (cyan) light, color filters transmitting Mg (magenta) light and color filters transmitting Ye (yellow) light are located. In addition, on the surfaces of a pair of image sensors located adjacently within the image sensors C (1,1), M (1,3), . . . Y (11,11), color filters transmitting different color light are located. Therefore, arrangement of color filters transmitting Cy (cyan) light, color filters transmitting Mg (magenta) light and color filters transmitting Ye (yellow) light are symmetrical and in a pattern.

The image sensors C (1,1), M (1,3), . . . , Y (11,11) receive light such as Cy (cyan), Mg (magenta) and Ye (yellow) and outputs image signals corresponding to a quantity of light. Although various types of embodiments were explained above, a virtual isosceles triangle may be a virtual right-angled isosceles triangle. In a virtual right-angled isosceles triangle, image processing at a latter stage becomes easy.

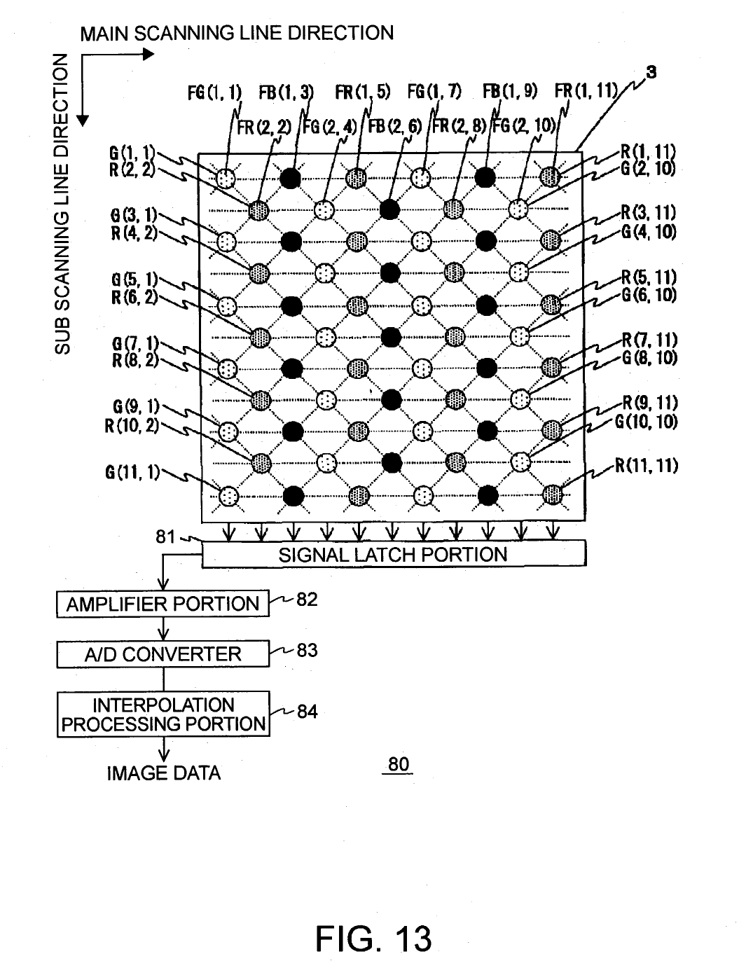

Next, an image-pickup circuit related to one embodiment of the present invention is described. FIG. 13 is a schematic figure showing an image-pickup circuit related to one embodiment of the present invention.

As shown in FIG. 13, an image-pickup circuit 80 is provided with a color area sensor 3, a signal latch portion 81, an amplifier portion 82, a A/D conversion portion 83 and an interpolation-processing portion 84.

The signal latch portion 81 latches a signal, which is outputted from the color area sensor 3.

The amplifier portion 82 is a circuit amplifying the signal, which is outputted from the signal latch portion 81. The A/D conversion portion 83 is the circuit, which converts the signal outputted by the amplifier portion 82 into digital data.

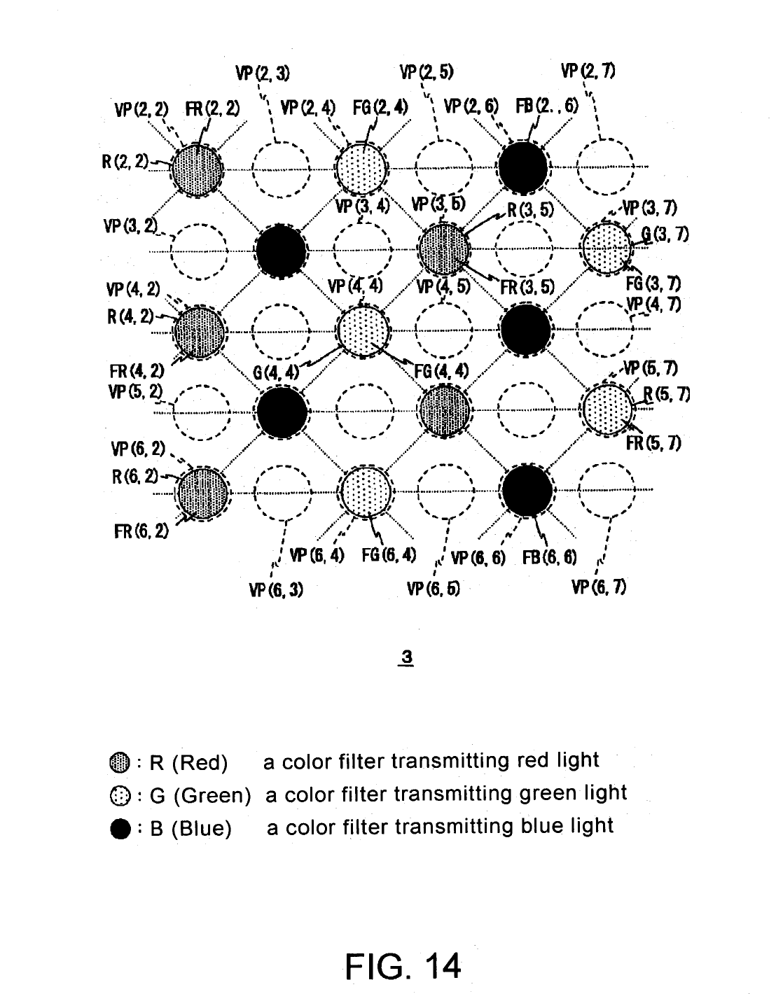

The interpolation-processing portion 84 interpolates digital data, outputted by the A/D conversion portion 83. Here, a schematic view of interpolation processing by the interpolation-processing portion 84 is described with referring to FIG. 14. FIG. 14 shows an enlarged figure of a part of the color area sensor 3. As shown in FIG. 14, virtual pixels VP (2,2) to. VP (6,7) are arranged at vertices and middle points of each of virtual right-angled isosceles triangles in the color area sensor 3. The interpolation-processing portion 84 amplifies output signals from the image sensors R (2,2) to B (6,6), A/D converts them and interpolates such digital data. Hence, image data (including R (red) data, G (green) data and B (blue) data) expressing the pixels VP (2,2) to VP (6,7) are calculated (here, as shown in FIG. 14, a case of virtual right-angled isosceles triangles among virtual isosceles triangles is explained with reference to drawings).

Interpolation processing by the interpolation-processing portion 84 is described particularly. Here, calculation of pixel data expressing the pixels VP (3,5), VP (4,5), VP (3,4) and VP (4,4) shown in FIG. 14 is described. Firstly, calculation of pixel data expressing the pixel VP (3,5) is described. At a position of the pixel VP (3,5), the image sensor R (3,5) and the color filter FR (3,5) are located. Hence, when digital data obtained by amplifying an output signal of the image sensor R (3,5) and A/D converting it is defined as Out (R (3,5)), VPD ((3,5), R), which is R (red) data expressing the pixel VP (3,5) among pixel data, becomes

VPD ((3,5), R)=Out(R (3,5)) (1)

The interpolation-processing portion 84 calculates VPD ((3,5), R) by operating an expression (1).

Next, calculating VPD ((3,5), G), which is G (green) data expressing the pixel VP (3,5) in pixel data, is explained. VPD ((3,5), G) can be expressed by using VPD ((3,4), G) and VPD ((3,7), G) as

VPD ((3,5), G)=⅓·{V PD ((3,4), G)·2+V PD ((3,7), G)} (2).

This is because the ratio of the distance between VP (3,5) and VP (3,4) to the distance between VP (3,5) and VP (3,7) is 1:2.

Here,

VPD ((3,4), G)=½·{V PD ((2,4), G)+VPD ((4,4), G)} (3)

Further,

VPD ((2,4), G)=Out (G (2,4) (4)

VPD ((4,4) G)=Out (G (4,4)) (5)

VPD ((3,7), G)=Out (G (3,7)) (6)

Therefore, the expression (2) becomes

VPD((3,5),G)=⅓·[½·(VPD((2,4),G)+VPD((4,4),G))·2+V PD((3,7),G)]=⅓·[VPD((2,4),G)+VPD((4,4), G)+VPD((3,7),G)]=⅓·(Out(G(2,4))+Out(G(4,4))+Out(G(3,7))) (7)

The interpolation-processing portion 84 calculates VPD ((3,5), G) by operating the expression (7).

Next, calculating VPD ((3,5), B), which is B (blue) data expressing the pixel VP (3,5) in pixel data, is described. VPD ((3,5), B) can be expressed by using VPD ((3,6), B) and VPD ((3,3), B) as

VPD ((3,5), B)=⅓·{V PD ((3,6), B)·2+V PD ((3,3), B)} (8)

Here,

VPD ((3,6), B)=½·{V PD ((2,6), B)+VPD ((4,6), B)} (9)

Further,

VPD ((3,3), B)=Out (B (3,3)) (10)

VPD ((2,6), B)=Out (B (2,6)) 11)

VPD ((4,6), B)=Out (B (4,6)) (12)

Therefore, the expression (8) becomes

VPD((3,5),B)=⅓[½·(VPD((2,6),B)+VPD((4,6),B))·2+V PD((3,3),B)]=⅓·[VPD((2,6),B)+VPD((4,6),B)+VPD((3,3),B)]=⅓·(Out(B(2,6))+Out(B(4,6))+Out(B(3,3))) (13)

The interpolation-processing portion 84 calculates VPD ((3,5), B) by operating the expression (13).

Thus, the interpolation-processing portion 84 calculates VPD ((3,5), R), VPD ((3,5), G) and VPD ((3,5), B) expressing the pixel VP (3,5) by operating the expressions (1), (7) and (13).

Next, calculating the pixel data expressing the pixel VP (4,5) is described.

First, calculating VPD ((4,5), R), which is R (red) data expressing the pixel VP (4,5) in pixel data, is described.

VPD ((4,5), R) can be expressed by using VPD ((3,5), R) and VPD ((5,5), R) as

VPD ((4,5), R)=½·(VPD ((3,5), R)+VPD ((5,5), R)) (14)

Here,

VPD ((3,5), R)=Out (R (3,5)) (15)

VPD ((5,5), R)=Out (R (5,5)) (16)

Therefore, the expression (14) becomes

VPD((4,5),R)=½·(VPD((3,5),R)+VPD((5,5),R))=½·(Out(R(3,5))+Out(R(5,5))) (17)

The interpolation-processing portion 84 calculates VPD ((4,5), R) by operating the expression (17).

Next, calculating VPD ((4,5), G), which is G (green) data expressing the pixel VP (4,5) in pixel data, is described.

VPD ((4,5), G) can be expressed by using VPD ((4,7), G) and VPD ((4,4), G) as

VPD ((4,5), G)=1/3·V PD ((4,7), G)+VPD ((4,4), G)·2} (18)

Here,

VPD ((4,7), G)=½·{V PD ((3,7), G)+VPD ((5,7), G)} (19)

Further,

VPD ((3,7), G)=Out (G (3,7)) (20)

VPD ((5,7), G)=Out (G (5,7)) (21)

VPD ((4,4), G)=Out (G (4,4)) (22)

Therefore, the expression (18) becomes

VPD((4,5),G)=1/3·[1/2·(VPD((3,7),G)+VPD((5,7),G))+VPD((4,4),G) 2]=1/6·[V PD((3,7),G)+VPD((5,7),G)+VPD((4,4),G)]=1/6·(Out(G(3,7))+Out(G(5,7))+4·Out(G(4,4))) (23)

The interpolation-processing portion 84 operates the expression (23) so as to calculate VPD ((4,5), G).

Next, calculating VPD ((4,5), B), which is B (blue) data of pixel data expressing pixel VP (4,5) is described.

VPD ((4,5), B) can be expressed by using VPD ((4,3), B) and VPD ((4,6), B) as

VPD ((4,5), B)=1/3·{V PD ((43), B)+VPD ((4,6), B)·2} (24)

Here,

VPD ((4,3), B)=½·{V PD ((3,3), B)+VPD ((5,3), B)} (25)

Further,

VPD ((3,3), B)=Out (B (3,3)) (26)

VPD ((5,3), B)=Out (B (5,3)) (27)

VPD ((4,6), B)=Out (B (4,6)) (28)

Therefore, the expression (24) becomes

VPD((4,5),B)=1/3·[1/2·(VPD((3,3),B)+VPD((5,3),B))+VPD((4,6),B)]=1/6·[VPD((3,3),B)+VPD((5,3),B)+4·VPD((4,6),B)]=1/6·(Out(B(3,3))+Out(B(5,3))+4·Out(B(4,6))) (29)

The interpolation-processing portion 84 operates the expression (29) so as to calculate VPD ((4,5), B).

Thus, the interpolation-processing portion 84 operates the expressions (17), (23) and (29) so as to calculate VPD ((4,5), R), VPD ((4,5), G) and VPD ((4,5), B) expressing the pixel VP (4,5).

Next, calculating pixel data to express the pixel VP (3,4) is described.

First, calculating VPD ((3,4), R), which is R (red) data of pixel data expressing the pixel VP (3,4), is described. VPD ((3,4), R) can be expressed by using VPD ((3,2), R) and VPD ((3,5), R) as

VPD ((3,4), R)=1/3·{V PD ((3,2), R)+VPD ((3,5), R)·2} (30)

Here,

VPD ((3,2), R)=½·{V PD ((2,2), R)+VPD ((4,2), R)} (31)

Further,

VPD ((2,2), R)=Out (G (2,2)) (32)

VPD ((4,2), R)=Out (G (4,2)) (33)

VPD ((3,5), R)=Out (G (3,5)) (34)

Therefore, the expression (31) becomes

VPD((3,4),R)=1/3·[1/2·(VPD((2,2),R)+VPD((4,2),R))+VPD((3,5),R)·2]=⅙·[VPD((2,2),R)+VPD((4,2),R)+4·VPD((3,5),R)]=1/6·(Out(R(2,2))+Out(R(4,2))+4·Out(R(3,5))) (35)

The interpolation-processing portion 84 operates the expression (35) so as to calculate VPD ((3,4), R).

Next, calculating VPD ((3,4), G), which is G (green) data of pixel data expressing the pixel VP (3,4) is described. PD ((3,4), G) can be expressed by using VPD ((2,4), G) and VPD ((4,4), G) as

VPD ((3,4), G)=½·(VPD ((2,4), G)+VPD ((4,4), G))) (36)

Here,

VPD ((2,4), G)=Out (G (2,4)) (37)

VPD ((4,4), G)=Out (G (4,4)) (38)

Therefore, the expression (36) becomes

VPD((3,4),G)=½·(VPD((2,4),G)+VPD((4,4),G))=½·(Out(G(2,4))+Out(G(4,4))) (39)

The interpolation-processing portion 84 operates the expression (39) so as to calculate VPD ((3,4), G).

Next, calculating VPD ((3,4), B), which is B (blue) data of pixel data expressing pixel VP (3,4), is described. The VPD ((3,4), B) can be expressed by using VPD ((3,6), B) and VPD ((3,3), B) as

VPD ((3,4), B)=1/3·{V PD ((3,6), B)+VPD ((3,3), B)·2} (40)

Here,

VPD ((3,6), B)=½·{V PD ((2,6), B)+VPD ((4,6), B)} (41)

Further,

VPD ((3,3), B)=Out (B (3,3)) (42)

VPD ((2,6), B)=Out (B (2,6)) (43)

VPD ((4,6), B)=Out (B (4,6)) (44)

Therefore, the expression (40) becomes

VPD((3,4),B)=1/3·[1/2·(VPD((2,6),B)+VPD(4,6),B)]+VPD((3,3),B)·2]=⅙·[V PD((2,6),B)+VPD((4,6),B)+4·VPD((3,3),B)]=1/6·(Out(B(2,6))+Out(B(4,6))+4·Out(B(3,3))) (45)

The interpolation-processing portion 84 operates the expression (45) to calculate VPD ((3,4), B).

Thus, the interpolation-processing portion 84 operates the expressions (35), (39) and (45) so as to calculate VPD ((3,4), R), VPD ((3,4), G) and VPD ((3,4), B) expressing the pixel VP (3,4).

Next, calculating pixel data for expressing the pixel VP (4,4) is described. Firstly, calculating VPD ((4,4), R), which is R (red) data of pixel data expressing the pixel VP (4,4) is described.

VPD ((4,4), R) can be expressed by using VPD ((4,5), R) and VPD ((4,2), R) as

VPD ((4,4), R)=1/3·{V PD ((4,5), R)·2+V PD ((4,2), R)} (46)

Here,

VPD ((4,5), R)=½·{V PD ((3,5), R)+VPD ((5,5), R)} (47)

Further,

VPD ((3,5), R)=Out (R (3,5)) (48)

VPD ((5,5), R)=Out (R (5,5)) (49)

VPD ((4,2), R)=Out (R (4,2)) (50)

Therefore, the expression (46) becomes

VPD((4,4),R)=1/3·[1/2·(VPD((3,5),R)+VPD((5,5),R))·2+V PD((4,2),R)]=1/3·[VPD((3,5),R)+VPD((5,5),R)+VPD((4,2),R)]=1/3·(Out(R(3,5))+Out(R(5,5))+Out(R(4,2))) (51)

The interpolation-processing portion 84 operates the expression (51) to calculate VPD ((4,4), R).

Next, calculating VPD ((4,4), G), which is G (green) data of pixel data expressing the pixel VP (4,4) is described. The image sensor G (4,4) and the color filter FG (4,4) are located at the position of the pixel VP (4,4).

Therefore,

VPD ((4,4), G)=Out (G (4,4)) (52)

The interpolation-processing portion 84 operates the expression (52) to calculate VPD ((4,4), G).

Next, calculating VPD ((4,4), B), which is B (blue) data of pixel data expressing pixel VP (4,4) is described.

VPD ((4,4), B) can be expressed by using VPD ((4,3), B) and VPD ((4,6), B) as

VPD ((4,4), B)=1/3·{V PD ((4,4), B)·2+V PD ((4,6), B)} (53)

Here,

VPD ((4,3), B)=½·{VPD ((3,3), B)+VPD ((5,3), B)} (54)

Further,

VPD ((3,3), B)=Out (B (3,3)) (55)

VPD ((5,3), B)=Out (B (5,3)) (56)

VPD ((4,6), B) Out (B (4,6)) (57)

Therefore, the expression (53) becomes

VPD((4,4),B)=1/3·[1/2·(VPD((3,3),B)+VPD((5,3),B))·2+V PD((4,6),B)]=1/3·[VPD((3,3),B)+VPD((5,3), B)+VPD((4,6),B)]=1/3·(Out(B(3,3))+Out(B(5,3))+Out(B(4,6))) (58)

The interpolation-processing portion 84 operates the expression (58) to calculate VPD ((4,4), B).

Thus, the interpolation-processing portion 84 operates the expressions (51), (52) and (58) to calculate VPD ((4,4), R), VPD ((4,4), G) and VPD ((4,4), B) expressing the pixel VP (4,4).

As discussed above, according to the present embodiment, the number of pixel data, which are 2 times of the number of image sensors in the main scanning line direction of the color area sensor 3 can be generated such that the number of pixel data, which are 2 times of the number of image sensors in the color area sensor 3 can be generated as the result.

As discussed above, according to the color area sensor related to the present invention, compared with the conventional sensor, color resolution can be increased, high resolution can be attained, all colors at the time of thinning can be read by a line unit, color shift at the time of thinning can be avoided, high speed reading can be realized and versatility of possible pattern arrangement in a sensor can be attained. In addition, according to the image-pick up circuit related to the present invention, generating the number of pixel data, which are 2 times of the number of image sensors in a color area sensor, can be realized by a simple processing circuit with less color shift.

The entire disclosure of Japanese Patent Application No.2002-126629 filed Apr. 26, 2002 is incorporated by reference.

What is claimed is:

1. A color area sensor comprising;
a plurality of image sensors located at coordinates of a virtual triangle lattice constituted by virtually arranging triangles; and
first, second and third color filters arranged on the light-receiving surfaces of the plurality of image sensors and transmitting first, second and third colors.

2. The color area sensor according to claim 1 wherein the first, second and third colors include R (red), G (green) and B (blue) or Cy (cyan), Ye (yellow) and Mg (magenta).

3. The color area sensor according to claim 1 wherein the triangles are equilateral triangles.

4. The color area sensor according to claim 1, wherein the triangles are isosceles triangles or right-angled isosceles triangles.

5. The color area sensor according to claim 1, wherein the first, second and third color filters are located at three vertices of the triangles.

6. The color area sensor according to claim 4, wherein the first color filters are located on the light-receiving surfaces of the image sensors at a J column (J=a natural number), the second color filters are located on the light-receiving surfaces of the image sensors at a J+1 column and the third color filters are located on the light-receiving surfaces of the image sensors at a J+2 column.

7. The color area sensor according to claim 4, wherein the first color filters are located on the light-receiving surfaces of the image sensors at a K row (K=a natural number), the second color filters are located on the light-receiving surfaces of the image sensors at a K+1 row and the third color filters are located on the light-receiving surfaces of the image sensors at a K +2 row.

8. The color area sensor according to claim 4, wherein the first, second and third color filters are located at the three vertices of the isosceles triangles formed on coordinates at L (L=a natural number) and L+1 rows, the color filters transmitting any two colors of the first and the second colors, the first and the third colors or the second and the third colors are located at the three vertices of isosceles triangles formed on coordinates at L+1 (L=a natural number) and L+2 rows.

9. The color area sensor according to claim 8, wherein the isosceles triangles are right-angled isosceles triangles.

10. The color area sensor according to claim 4, wherein the first color filters are located on the light-receiving surfaces of the image sensors at an M row (M=a natural number), the second and the third color filters are alternatively located on the light-receiving surfaces of the image sensors at an M+1 row.

11. The color area sensor according to claim 4, further comprising an output line transmitting an image signal outputted from the image sensors at each column.

12. The color area sensor according to claim 4, further comprising an output line transmitting an image signal outputted from the image sensors at two columns located adjacent to each other.

13. The color area sensor according to claim 11, wherein the output line is a polygonal-shaped line.

14. The color area sensor according to claim 1, wherein the image sensors are CMOS type image sensors.

15. The color area sensor according to claim 14, further comprising a selecting line transmitting a selection signal that selects the image sensors at each row.

16. The color area sensor according to claim 14, further comprising a selection line transmitting a selection signal that selects the image sensors at two rows located adjacent to each other.

17. The color area sensor according to claim 15, wherein the selection line is a polygonal-shaped line.

18. The color area sensor according to claim 1, wherein the image sensors are image sensors including CCD transmission circuits.

19. An image-pick up circuit comprising:
the color area sensor according to claim 4;
a latch portion latching an output signal of the color area sensor;
an amplifier amplifying an output signal of the latch portion,
an A/D converter A/D converting the output signal of the amplifier; and
an interpolation-processing portion interpolating the output signal from the A/D converter so as to calculate pixel data.

20. An image pick up circuit comprising:
the color area sensor according to claim 6 provided with the first color filters located at predetermined lattice points (R,J) (R, J=natural numbers);
a latch portion latching an output signal of the color area sensor;
an amplifier amplifying an output signal of the latch portion;
an A/D converter A/D converting the output signal of the amplifier; and
an interpolation-processing portion, amplifying and AID converting output signals of the image sensors located at the lattice point (T, U) (T, U=natural numbers) into data Out (T,U),
calculating pixel data of the first color VPD (((R+1), (J+3)), 1) at the first pixel VP ((R+1), (J+3)) by using a formula VPD(((R+1),(J+3)),1)=Out((R+1),(J+3)),
calculating pixel data of the second color VPD (((R+1), (J+3)), 2) at the pixel VP ((R+1), (J+3)) by using a formula VPD(((R+1),(J+3)),2)=1/3·(Out(R, (J+4))+Out((R+2),(J+4))+Out((R+1),(J+))),
and calculating pixel data of the third color VPD (((R+1), (J+3)), 3) at the pixel VP ((R+1), (J+3)) by using a formula VPD(((R+1), (J+3)), 3)=1/3·(Out(R, (J+2))+Out((R+2),(J+2))+Out((R+I),(J+5))), based on the data Out (T,U).

21. An image pick up circuit comprising:
the color area sensor according to claim 6 provided with first color filters located at predetermined lattice points (R,J) (R, J=natural numbers);
a latch portion latching an output signal of the color area sensor;
an amplifier amplifying an output signal of the latch portion;
an A/D converter A/D converting the output signal of the amplifier; and
an interpolation-processing portion, amplifying and AID converting output signals of the image sensors located at the point (T, U) (T, U=natural numbers) into data Out (T,U),
calculating pixel data of first color VPD (((R+2), (J+3)), 1) at the first pixel VP ((R+2), (J+3)) by using a formula VPD(((R+2),(J+3)),1)=½·(Out((R+1),(J+3))+Out((R+3),(J+3))),
calculating pixel data of the second color VPD (((R+2), (J+3)), 2) at the pixel VP ((R+2), (J+3)) by using a formula VPD(((R+2),(J+3)),2)=1/6·(Out((R+1),(J+1))+Out((R+3),(J+1))+Out((R+2),(J+4))),
and calculating pixel data of the third color VPD (((R+2), (J+3)), 3) at the pixel VP ((R+2), (J+3)) by using a formula VPD(((R+2),(J+3)),3)=1/6·(Out((R+1), (J+5))+Out ((R+3), (J+5)+4 Out ((R+2),(J+2))), based on the data Out (T,U).

22. An image pick up circuit comprising:
the color area sensor according to any one of claim 6 provided with first color filters located at predetermined lattice points (R,J) (R, J=natural numbers);
a latch portion latching an output signal of the color area sensor;
an amplifier amplifying an output signal of the latch portion;
an A/D converter A/D converting the output signal of the amplifier; and
an interpolation portion amplifying and A/D converting output signals of the image sensors located at the lattice point (T, U) (T, U=natural numbers) into data Out (T,U),
calculating a pixel data of the first color VPD (((R+1), (J+2)), 1) at the first pixel VP ((R+1), (J+2)) by using a formula VPD (((R+1), (J+2)), 1)=1/6·(Out(R,J)+Out((R+2),J)+4 Out((R+1),(J+3))),
calculating a pixel data of the second color VPD (((R+1), (J+2)), 2) at the pixel VP ((R+1), (J+2)) by using a formula VPD(((R+1),(J+2)),2)=1/6·(Out(R,(J+4))+Out((R+2),(J+4))+4 Out((R+1),(J+1))), and
calculating a pixel data of the third color VPD (((R+1), (J+2)), 3) at the pixel VP ((R+1), (J+2)) by using a formula VPD(((R+1),(J+2)),3)=½·(Out(R,(J+2))+Out((R+2),(J+2))), based on the data Out (T,U).

23. An image pick up circuit comprising:
the color area sensor according to claim 11 provided with the first color filters located at a predetermined lattice point (R,J) (R, J=natural numbers);
a latch portion latching an output signal of the color area sensor;
an amplifier amplifying an output signal of the latch portion;
an A/D converter A/D converting the output signal of the amplifier; and
an interpolation-processing portion amplifying and A/D converting output signals of the image sensors located at the point (T, U) (T, U=natural numbers) into data Out (T,U),
calculating a pixel data of the first color VPD (((R+2), (J+2)), 1) at the first pixel VP ((R+2), (J+2)) by using a formula VPD (((R+2), (J+2)), 1)=1/3·(Out(R+2,J)+Out((R+1),(J+3)+Out((R+1),(J+3))),
calculating pixel data of the second color VPD (((R+2), (J+2)), 2) at the pixel VP ((R+2), (J+2)) by using a formula VPD(((R+2),(J+2)),2)=1/3·(Out((R+1), (J+1))+Out((R+3), (J+1))+Out((R+2), (J+4))), calculating pixel data of the third color VPD (((R+2), (J+2)), 3) at the pixel VP ((R+2), (J+2)) by using a formula VPD(((R+2),(J+2)),3)=Out((R+2),(J+2)), based on the data Out (T,U).
